(19) United States
(12) Patent Application Publication
(10) Pub. No.: US 2025/0289069 A1
(43) Pub. Date: Sep. 18, 2025

(54) WORK MACHINE

(71) Applicant: Koki Holdings Co., Ltd., Tokyo (JP)

(72) Inventor: Umaru MATSUURA, Ibaraki (JP)

(73) Assignee: Koki Holdings Co., Ltd., Tokyo (JP)

(21) Appl. No.: 18/860,693

(22) PCT Filed: Apr. 27, 2023
(86) PCT No.: PCT/JP2023/016761

§ 371 Date: Oct. 28, 2024

(30) Foreign Application Priority Data
Apr. 28, 2022 (JP) 2022-075237
Jun. 17, 2022 (JP) 2022-098424

(51) Int. Cl. B23D 29/00; B23D 15/04; B25F 5/02

(52) U.S. Cl. CPC B23D 29/00; B23D 15/04; B25F 5/02

(57) ABSTRACT

In an electric cutting machine, in a side view, a center of gravity of the electric cutting machine is located at a position overlapping with a blade in an up-down direction of the electric cutting machine. In other words, in the side view, the center of gravity of the electric cutting machine is located within a range of a width dimension of the blade in the up-down direction. Thus, in an upright posture of the electric cutting machine, the center of gravity of the electric cutting machine is located on a vertically lower side of the blade for cutting a workpiece.

### TECHNICAL FIELD

The present invention relates to a work machine.

### RELATED ART

In an electric reciprocating tool (work machine) described in Patent Document 1 below,

a receiving plate is provided at a front end part of the electric reciprocating tool, and a blade holder is provided on a rear side of the receiving plate. Further, a housing is provided on the rear side of the blade holder, and the housing is configured to include a motor chamber extended in a front-rear direction and a handle extended in a direction intersecting with the motor chamber. By setting a workpiece to the receiving plate and operating a main switch of the handle, a movable blade moves toward a front side to perform a cutting processing on the workpiece.

### RELATED ART DOCUMENTS

### Patent Documents

Patent Document 1: Japanese Patent Application Laid-Open No. 2001-277039

### SUMMARY OF INVENTION

### Problem to Be Solved by Invention

However, in the above electric reciprocating tool, there is room for improvement in terms of the following points. Namely, for example, when performing a cutting processing on a workpiece such as a light gauge steel (LGS) fixed to a ceiling and the like, it is required to set the light gauge steel, which is located on a vertically upper side of the operator, to the receiving plate of the electric reciprocating tool. Specifically, a longitudinal direction of the electric reciprocating tool is aligned with the vertical direction, and the electric reciprocating tool is suspended from the light gauge steel. In this case, if the posture of the electric reciprocating tool tilts with respect to the vertical direction, there is a possibility that a finish at a cut surface of the light gauge steel may deteriorate. Thus, in this case, it is required to perform the work while correcting the posture of the electric reciprocating tool to align with the vertical direction, which may lead to a decrease in operability. Further, when performing the cutting processing on a workpiece such as a light gauge steel fixed to a ceiling and the like, it is required to set the light gauge steel, which is located on the vertically upper side of the electric reciprocating tool, to the receiving plate. At this time, in the above electric reciprocating tool, since the position of the handle is offset from the position at which the light gauge steel is set, there is a misalignment between the operator's hand and the position of the light gauge steel, and it is difficult to recognize the position of the receiving plate with respect to a target cutting position. Accordingly, there is a possibility that operability may decrease when setting the light gauge steel to the receiving plate. Further, if the position of the handle is offset from the position at which the light gauge steel is set, there is a risk that the handle may hit a wall during the work on a light gauge steel located near a wall, and operability may decrease.

An objective of the present invention is to provide a work machine capable of improving operability in consideration of the above facts.

### Means for Solving Problem

One or more embodiments of the present invention is a work machine including a housing and a cutting tool. The housing extends in a first direction. The cutting tool is provided to be capable of reciprocating in the first direction on one side of the housing in the first direction, is formed into a plate shape with a second direction orthogonal to the first direction as a width direction and a third direction orthogonal to the first direction and the second direction as a plate thickness direction, and cuts a light gauge steel by moving toward the one side in the first direction. Upon viewing from the third direction, a center of gravity of the work machine is located at a position overlapping with the cutting tool in the second direction.

One or more embodiments of the present invention is the work machine, in which the housing includes a gripping part, and at least a part of the gripping part is disposed at a position overlapping with the center of gravity in the first direction.

One or more embodiments of the present invention is the work machine, in which the gripping part extends in the first direction.

One or more embodiments of the present invention is the work machine, in which a support part supporting the light gauge steel is provided on the one side in the first direction with respect to the cutting tool. A blade part in a V-shape that is convex toward the one side in the first direction upon viewing from the third direction is formed at a one-side end part of the cutting tool in the first direction. In the second direction, a tip part of the blade part is disposed at a position offset to one side in the second direction with respect to a central part of the support part in the second direction, and the center of gravity is located at a position offset to another side in the second direction with respect to the central part of the support part in the second direction.

One or more embodiments of the present invention is a work machine, in which a motor for causing the cutting tool to reciprocate is accommodated in the housing. The motor is disposed at a position offset to the one side in the second direction with respect to the central part of the support part in the second direction.

One or more embodiments of the present invention is the work machine, in which a power supply part for supplying power to the motor is provided at the housing, and the power supply part is disposed at a position offset to the another side in the second direction with respect to a center of the support part in the second direction.

One or more embodiments of the present invention is the work machine, in which, upon viewing from the third direction, a part of the gripping part is located outside a virtual circle that is centered on the central part of the support part in the second direction and passes through the center of gravity.

One or more embodiments of the present invention is the work machine, in which, upon viewing from the third direction, a part of the gripping part is located at a position overlapping with the support part in the second direction.

### Effects of Invention

According to one or more embodiments of the present invention, operability can be improved.

### BRIEF DESCRIPTION OF DRAWINGS

FIG. 1 is a side view viewed from a left side showing an electric cutting machine according to First Embodiment.

FIG. 2 is a partially cut side view viewed from the left side showing an inside of the electric cutting machine illustrated in FIG. 1.

FIG. 3 is a cross-sectional view (cross-sectional view taken along line 3-3 in FIG. 1) viewed from a rear side showing an enlarged view of a middle part in a front-rear direction of a gripping part illustrated in FIG. 1.

FIG. 4 is a flowchart for describing an action of the electric cutting machine according to First Embodiment.

FIG. 5 is an illustrative view for describing a tilt in an upright posture of an electric cutting machine of a comparative example with a position of center of gravity shifted.

FIG. 6 is a side view viewed from the left side showing an inside and a position of center of gravity of an electric cutting machine according to Second Embodiment.

FIG. 7 is a perspective view of the electric cutting machine illustrated in FIG. 6.

FIG. 8(A) is a side view viewed from the left side showing an inside and a position of center of gravity of an electric cutting machine according to Third Embodiment, and (B) is a schematic cross-sectional view (cross-sectional view taken along line 8B-8B in FIG. 8(A)) at a connecting part of the electric cutting machine in (A) viewed from a front side.

FIG. 9 is a perspective view of the electric cutting machine illustrated in FIG. 8.

FIG. 10 is a side view viewed from the left side showing an inside and a position of center of gravity of an electric cutting machine according to Fourth Embodiment.

FIG. 11 is perspective view of the electric cutting machine illustrated in FIG. 10.

FIG. 12 is a side view viewed from the left side showing an inside and a position of center of gravity of an electric cutting machine according to Fifth Embodiment.

FIG. 13 is a perspective view of the electric cutting machine illustrated in FIG. 12.

FIG. 14(A) is a side view viewed from the left side showing an electric cutting machine according to Sixth Embodiment, and (B) is a side view viewed from the left side showing an inside of the electric cutting machine in (A).

FIG. 15(A) is a side view viewed from the left side showing an electric cutting machine according to Seventh Embodiment, and (B) is a side view viewed from the left side showing an inside of the electric cutting machine in (A).

FIG. 16(A) is a side view viewed from the left side showing an electric cutting machine according to Eighth Embodiment, and (B) is a side view viewed from the left side showing an inside of the electric cutting machine in (A).

FIG. 17(A) is a side view viewed from the left side showing an electric cutting machine according to Ninth Embodiment, and (B) is a side view viewed from the left side showing an inside of the electric cutting machine in (A).

FIG. 18(A) is a side view viewed from the left side showing an electric cutting machine according to Tenth Embodiment, and (B) is a side view viewed from the left side showing an inside of the electric cutting machine in (A).

### DESCRIPTION OF EMBODIMENTS

### First Embodiment

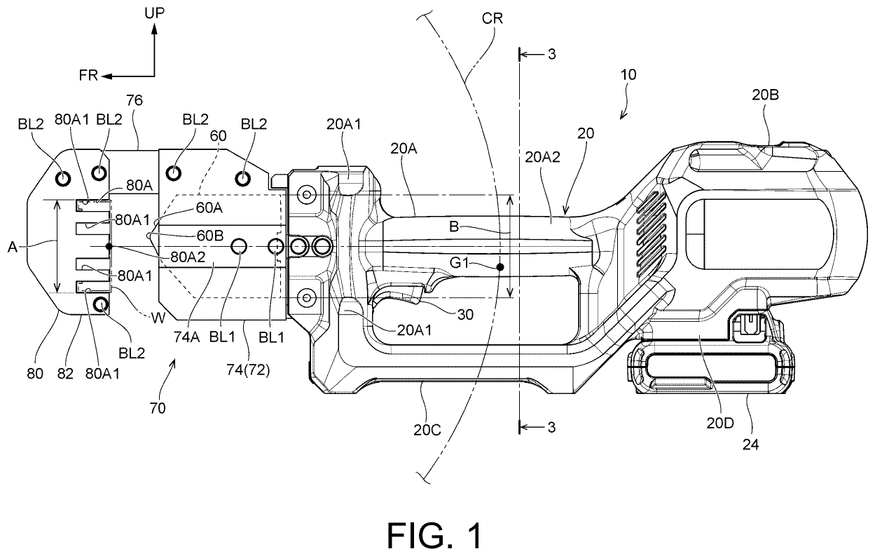

Hereinafter, an electric cutting machine 10 will be described as a work machine according to First Embodiment with reference to FIG. 1 to FIG. 5. In the drawings, an arrow UP, an arrow FR, and an arrow LH shown as appropriate indicate an upper side, a front side, and a left side of the electric cutting machine 10, respectively. In the following description, when describing with up-down, front-rear, and left-right directions, unless specifically stated otherwise, these refer to an up-down direction, a front-rear direction, and a left-right direction of the electric cutting machine 10. Further, the front-rear direction corresponds to a first direction of the present invention, the up-down direction corresponds to a second direction of the present invention, and the left-right direction corresponds to a third direction of the present invention.

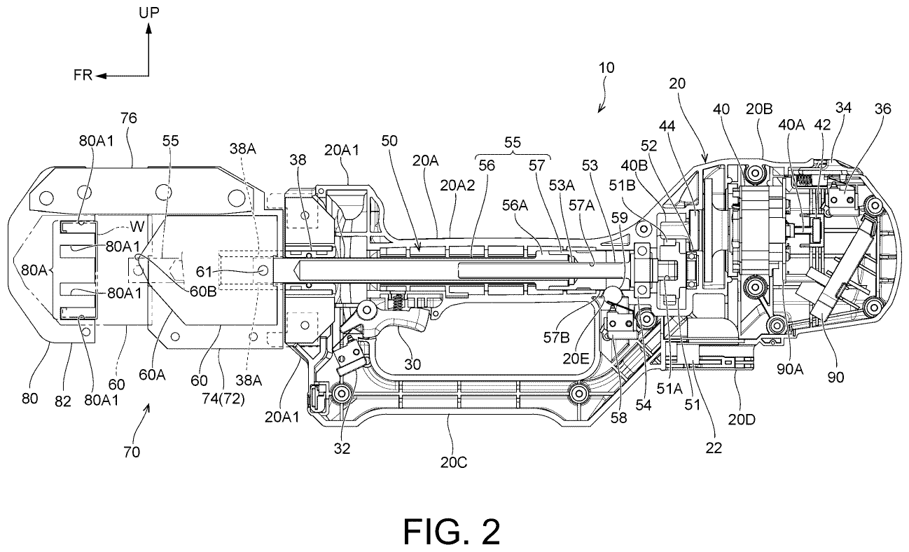

As shown in FIG. 1 and FIG. 2, the electric cutting machine 10 is configured as an electric tool for performing a cutting processing on a workpiece W, which serves as a light gauge steel used in a suspended ceiling of a building. The workpiece W is formed into an elongated columnar shape, and is formed into a substantially U-shape when viewed from a longitudinal direction thereof. The light gauge steel is made of metal, and naturally, has a cross-section (in a direction orthogonal to the longitudinal direction) that is also in a substantially U-shape. The electric cutting machine 10 is configured to include a housing 20, a motor 40, a feed screw mechanism 50 (an element broadly understood as a moving mechanism), a blade 60 as a cutting tool, a guide mechanism 70, and a controller 90. Hereinafter, each configuration of the electric cutting machine 10 will be described.

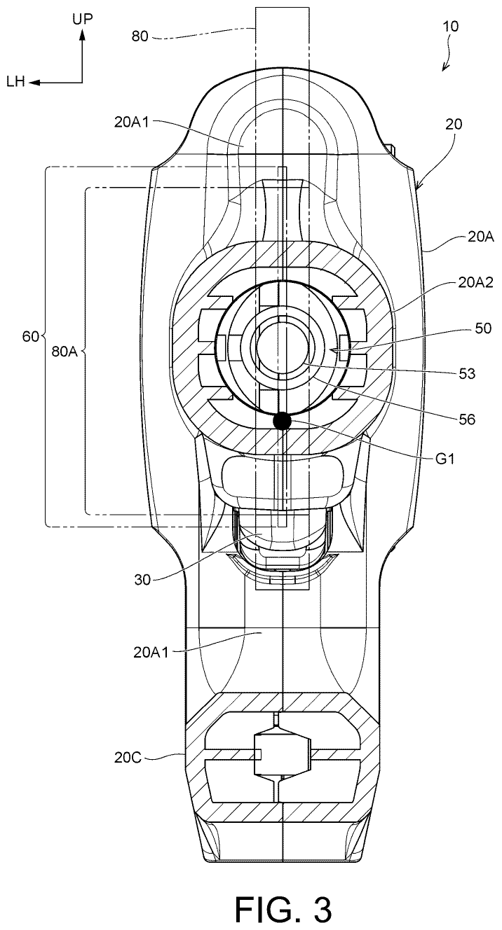

(Regarding housing 20) The housing 20 constitutes an outer frame of the electric cutting machine 10 and is extended in the front-rear direction as a whole. The housing 20 is configured to include a handle housing part 20A constituting a front part of the housing 20, and a motor housing part 20B constituting a rear part of the housing 20. The handle housing part 20A is formed into a substantially rectangular tubular shape extended in the front-rear direction. A pair of overhang parts 20A1 overhanging toward both sides in the up-down direction are formed at a front end part of the handle housing part 20A. A handle guard 20C as a guard part is provided on the lower side of the handle housing part 20A. The handle guard 20C is formed into a substantially rectangular tubular shape extended in the front-rear direction. A front end part of the handle guard 20C is bent toward the upper side and is connected to the lower overhang part 20A1. A rear end part of the handle guard 20C is bent diagonally upward toward the rear side and is connected to a rear end part of the handle housing part 20A. A portion of the handle housing part 20A between the front end part and the rear end part of the handle guard 20C is configured as a gripping part 20A2 for an operator to grip. In other words, the gripping part 20A2 is extended in the front-rear direction on the rear side of the overhang parts 20A1. A left-right dimension of the front end part of the handle housing part 20A including the pair of overhang parts 20A1 is set to be larger than a left-right dimension of the gripping part 20A2, and the front end part of the handle housing part 20A is overhung more outward in the left-right direction than the gripping part 20A2 (refer to FIG. 3).

The motor housing part 20B is formed into a substantially flat shape with the left-right direction as a thickness direction thereof. A thickness dimension of the motor housing part 20B is set to be larger than a thickness dimension (dimension in the left-right direction) of the handle housing part 20A. An upper end part of the motor housing part 20B protrudes more upward than the handle housing part 20A, and a lower end part of the motor housing part 20B is located more upward than the handle guard 20C.

A trigger 30 serving as an operation part for instructing movement start (start of the cutting processing) of the blade 60 (to be described later) is provided at a front end part of the gripping part 20A2. The trigger 30 protrudes toward the lower side from the gripping part 20A2 in a manner capable of being pull-operated toward the upper side. A trigger switch 32 is provided at the front end part of the handle housing part 20A on the lower side of the trigger 30. By performing a pull operation on the trigger 30, the trigger switch 32 switches from off to on. By releasing the pulling operation on the trigger 30, the trigger switch 32 switches from on to off.

The trigger switch 32 is electrically connected to the controller 90 (to be described later), and the controller 90 is accommodated in a rear end part of the motor housing part 20B. Upon turn-on of the trigger switch 32, the trigger switch 32 outputs an on-signal to the controller 90.

Further, a battery mounting part 20D serving as a battery mounting part is provided at the lower end part of the motor housing part 20 on the rear side of the handle guard 20C. A battery terminal 22 serving as a power supply part for supplying power to the motor 40 is provided at the battery mounting part 20D, and the battery terminal 22 is electrically connected to the controller 90 (to be described later). A battery 24 serving as a battery is detachably mounted to the battery mounting part 20D, and the battery 24 includes a connector (not shown) connected with the battery terminal 22. Accordingly, a configuration is formed in which power is supplied to the motor 40 (to be described later) via the controller 90. Further, a position of a lower end of the battery 24 in the up-down direction is aligned with a position of a lower end of the handle guard 20C. In other words, the battery 24 is set not to protrude more downward than the handle guard 20C. Further, the rear end part of the motor housing part 20B protrudes more rearward than the battery 24 and, in a side view, is curved in a substantially arc shape that is convex toward the rear side.

A sub-trigger 34 (an element broadly understood as an erroneous operation suppressing part) for suppressing an erroneous operation on the trigger 30 is provided at the upper end part of the motor housing part 20B. The sub-trigger 34 is configured to be slidable toward the front side. A sub-trigger switch 36 is provided in the upper end part of the motor housing part 20B on the lower side of the sub-trigger 34, and the sub-trigger switch 36 is electrically connected to the controller 90 (to be described later). By performing a slide operation on the sub-trigger 34, the sub-trigger switch 36 switches from off to on and outputs an on-signal to the controller 90. By releasing the slide operation on the sub-trigger 34, the sub-trigger 34 moves toward the rear side, and the sub-trigger switch 36 switches from on to off. Further, the electric cutting machine 10 is configured such that, at the start of the cutting processing, by turning on the trigger switch 32 after the sub-trigger switch 36 is turned on, forward drive of the motor 40 (to be described later) is permitted. In other words, the sub-trigger 34 is configured as an operation part for suppressing an erroneous operation of the trigger 30 at the start of the cutting processing.

An inner guide 38 is provided at the front end part of the handle housing part 20A, and the inner guide 38 is formed into a substantially cylindrical shape with the front-rear direction as an axial direction thereof. A rear part of the inner guide 38 is supported by the handle housing part 20A, and a front part of the inner guide 38 protrudes toward the front side from the handle housing part 20A. A pair of upper and lower slits 38A for disposing the blade 60 (to be described later) are formed at the front part of the inner guide 38. The slits 38A are extended in the front-rear direction and penetrate in the up-down direction, and front end parts of the slits 38A are opened toward the front side.

(Regarding motor 40) The motor 40 is configured as a brushless motor and is accommodated in the front part of the motor housing part 20B. The motor 40 includes a drive shaft 40A with the front-rear direction and an axial direction thereof. A rear end part of the drive shaft 40A is rotatably supported by a motor bearing 42 held by the housing 20, and a front end side portion of the drive shaft 40A is rotatably supported by a motor bearing 44 held by the housing 20. A pinion gear 40B is formed at a front end part of the drive shaft 40A. The motor 40 is electrically connected to the controller 90 and is driven according to control of the controller 90. (Regarding feed screw mechanism 50) The feed screw mechanism 50 is configured to

include a transmission gear 51, a drive shaft 53 (an element broadly understood as an output shaft), a lifter 55 (an element broadly understood as a moving member), and a lifter detection switch 58 (an element broadly understood as an initial position detection part) for detecting an initial position of the lifter 55.

The transmission gear 51 is formed into a substantially stepped cylindrical shape with the front-rear direction as an axial direction thereof, and a diameter of a front part of the transmission gear 51 is set to be larger than a diameter of a rear part of the transmission gear 51. A gear recess 51A that is opened toward the front side is formed at a central part on a front surface of the transmission gear 51. The transmission gear 51 is disposed on the lower side of a front end part of the drive shaft 40A of the motor 40, and the rear part of the transmission gear 51 is rotatably supported by a gear bearing 52 held by the housing 20. A gear part 51B is formed at an outer circumferential part of the front part of the transmission gear 51, and the gear part 51B is meshed with the pinion gear 40B of the drive shaft 40A.

The drive shaft 53 is formed into a substantially cylindrical shape with the front-rear direction as an axial direction thereof. The drive shaft 53 is accommodated in the handle housing part 20A, and is disposed on the front side of the transmission gear 51 and coaxially with the transmission gear 51. A rear end part of the drive shaft 53 is fitted into the gear recess 51A of the transmission gear 51 in a manner capable of rotating integrally, and a rear end side portion of the drive shaft 53 is rotatably supported by a shaft bearing 54 held by the housing 20. Accordingly, by driving the motor 40, the drive shaft 53 rotates. A male screw 53A is formed at an outer circumferential part of the drive shaft 53, at a portion excluding a rear end part.

The lifter 55 is formed into a substantially elongated shape extended in the front-rear direction as a whole. The lifter 55 is configured to include a lifter body 56, and a lifter connecting part 57 that constitutes a rear end part of the lifter 55. The lifter connecting part 57 is formed into a substantially stepped cylindrical shape with the front-rear direction as an axial direction thereof. A female screw 57A is formed at an inner circumferential part of a rear part of the lifter connecting part 57. A front part of the drive shaft 53 is inserted inside the lifter connecting part 57, and the male screw 53A of the drive shaft 53 is screwed with the female screw 57A of the lifter connecting part 57. In other words, the drive shaft 53 and the lifter 55 are screw-fitted together.

Accordingly, a configuration is formed in which, by rotating the drive shaft 53, the lifter 55 moves in the front-rear direction. Specifically, the lifter 55 reciprocates between an initial position (a position indicated by a solid line in FIG. 2) and a processing position (a position indicated by a double-dot dash line in FIG. 2). Further, an outer circumferential part of the rear end part of the lifter connecting part 57 is configured as a detected part 57B.

The lifter body 56 is formed into a substantially bottomed cylindrical shape opened toward the rear side. A rear end part of the lifter body 56 is fitted into the front part of the lifter connecting part 57, and the lifter connecting part 57 and the lifter body 56 are connected in a manner incapable of moving relatively to each other. At the initial position of the lifter 55, the front part of the drive shaft 53 is inserted inside the lifter body 56 in a manner capable of moving relatively to each other. A front end part of the lifter body 56 is supported by the inner guide 38 provided at the front end part of the handle housing part 20A in a manner capable of moving relatively to each other in the front-rear direction.

A lifter flange 56A is formed on an outer circumferential part of a rear end side portion of the lifter body 56, and the lifter flange 56A is formed into a disc shape protruding toward a radially outer side of the lifter body 56. Although not shown in the figure, at the processing position of the lifter 55, the lifter flange 56A is disposed in close proximity to the rear side of the inner guide 38.

The lifter detection switch 58 is configured as a lever-type microswitch and is accommodated in the rear end part of the handle guard 20C. A ball 59 in a spherical shape is provided on the upper side of the lifter detection switch 58, and the ball 59 is disposed in a ball hole part 20E formed at an outer circumferential lower end part of the handle housing part 20A. The ball hole part 20E penetrates in the up-down direction, and a diameter of the ball hole part 20E increases toward the lower side. In an off-state of the lifter detection switch 58, an outer circumferential surface of the ball 59 abuts against a lever part of the lifter detection switch 58 and an inner circumferential surface of the ball hole part 20E. Further, in this state, a part of an outer circumferential part of the ball 59 protrudes toward a radially inner side with respect to an inner circumferential surface of the handle housing part 20A and is disposed in the handle housing part 20A.

When the lifter 55 is disposed at the initial position, the detected part 57B of the lifter 55 presses the ball 59 toward the radially outer side (lower side), and the ball 59 displaces toward the lifter detection switch 58 side (lower side). In other words, the configuration is set such that, when the lifter 55 reaches the initial position from the processing position of the lifter 55 during a movement toward a return path side toward the initial position, the ball 59 presses the lever part of the lifter detection switch 58, and the lifter detection switch 58 switches from off to on. The lifter detection switch 58 is electrically connected to the controller 90 and outputs a detection signal to the controller 90.

(Regarding blade 60) The blade 60 is formed into a plate shape extending in up-down and front-rear directions, with the left-right direction as a plate thickness direction thereof. A rear end part of the blade 60 is fixed to the front end part of the lifter 55 by a screw 61.

Accordingly, the blade 60 is configured to be movable integrally with the lifter 55 between the initial position and the processing position. The rear end part of the blade 60 is inserted into the slits 38A of the inner guide 38. A blade part 60A for cutting the workpiece W is formed at a front end part of the blade 60. The blade part 60A is configured as a single-edged blade and is formed into a substantially V-shape that is convex toward the front side when viewed from the left-right direction.

At the initial position of the blade 60, the blade 60 is disposed adjacent to the front side of the housing 20 and is disposed on the rear side the workpiece W. By moving the blade 60 toward the front side from the initial position, the cutting processing on the workpiece W is performed. Furthermore, the configuration is set such that the cutting processing on the workpiece W is completed at the processing position of the blade 60.

(Regarding guide mechanism 70) The guide mechanism 70 is configured to include a blade holder 72, a connecting member 76, and a head part 80 serving as a processing part. The head part 80 functions as a member (support part) that supports the workpiece W. Although the workpiece W serving as a light gauge steel may be fixed at a specific spot (e.g., a wall and a ceiling), in the present invention, a state in which the head part 80 is engaged with a workpiece W in such a fixed state is also regarded as a state in which the workpiece W is supported by the head part 80.

The blade holder 72 includes a pair of left and right holder plates 74. The holder plates 74 are constituted by a metal plate material and are formed into a substantially rectangular plate shape with the left-right direction as a plate thickness direction thereof. A fixed part 74A is formed at a middle part in the up-down direction of the holder plate 74, and the fixed part 74A is formed into a substantially arc shape that is convex toward an outer side in the left-right direction when viewed from the front side. The fixed part 74A is disposed on the radially outer side of the inner guide 38 and is fastened and fixed to the inner guide 38 by a pair of front and rear bolts BL1. Accordingly, the holder plates 74 are fixed to the inner guide 38.

The pair of holder plates 74 are disposed opposed to each other with a predetermined gap in the left-right direction. An opposing distance at lower parts of the pair of holder plates 74 is set to be slightly longer than the plate thickness of the blade 60, and the blade 60 is disposed between the pair of holder plates 74. Accordingly, during rotation of the drive shaft 53, the lower part of the blade holder 72 restricts rotation of the lifter 55 and the blade 60 together with the drive shaft 53, and a reciprocating movement of the blade 60 in the front-rear direction is guided by the blade holder 72.

The connecting member 76 is constituted by a metal plate material and is formed into a substantially elongated plate shape extended in the front-rear direction, with the left-right direction as a plate thickness direction thereof. The connecting member 76 is disposed between upper end parts of the pair of holder plates 74 and is fastened and fixed to the holder plates 74 by bolts BL2.

The head part 80 includes a pair of left and right head plates 82. The head plates 82 are constituted by a metal plate material and are formed into a plate shape with the left-right direction as a plate thickness direction thereof. The pair of head plates 82 are disposed on the front side of the holder plates 74 and on the left-right outer sides of the connecting member 76. Upper end parts of the head plates 82 are fastened and fixed to front end parts of the connecting member 76 by the bolts BL2. Accordingly, the pair of head plates 82 are disposed opposed to each other with a predetermined interval in the left-right direction.

A support part 80A for supporting the workpiece W is formed at a rear end part of the head part 80, and the support part 80A is formed into a substantially comb shape opened toward the rear side with the up-down direction as a width direction thereof. In other words, a plurality (four spots in the present embodiment) of notch parts 80A1 opened toward the rear side are formed through the support part 80A, and several notch parts 80A1 are disposed in a row with predetermined intervals in the width direction of the support part 80A. During the cutting processing on the workpiece W, both end parts of the workpiece W, as viewed from a longitudinal direction of the workpiece W, are inserted into the notch parts 80A1 to set (support) the workpiece W to the head part 80. Thus, the workpiece W is supported by the head part 80 while a part of the workpiece W is positioned in the notch part 80A1. In the present embodiment, since the notch part 80A1 is provided at four spots, it is possible to handle cutting of workpieces W with widths corresponding to combinations of recesses.

Further, in a side view, the entire gripping part 20A2 of the housing 20 is disposed at a position overlapping with the support part 80A of the head part 80 in the up-down direction (at a same position in the up-down direction). In other words, when viewed from the left-right direction, the gripping part 20A2 is disposed within a range of a width dimension A (refer to FIG. 1) of the comb-shaped support part 80A and extends in the front-rear direction. In other words, when viewed from the front-rear direction, the gripping part 20A2 and the support part 80A overlap with each other, and the gripping part 20A2 is disposed directly behind the support part 80A (guide mechanism 70) (refer to FIG. 3). During the cutting processing on the workpiece W, the blade 60 moving toward the front side is inserted between the pair of head plates 82 to perform the cutting processing on the workpiece W supported by the support part 80A. The width dimension A is a range from one end to the other end in a predetermined direction (up-down direction) of the plurality of notch parts 80A1 arranged in a row in the predetermined direction.

Further, the width dimension A of the support part 80A is set to be slightly smaller than a width dimension B (dimension in the up-down direction) of the blade 60, and when viewed from the left-right direction, the support part 80A is disposed within a range of the width dimension B of the blade 60. Furthermore, in the side view, a tip part 60B of the blade part 60A of the blade 60 is disposed at a position offset toward the upper side with respect to a central part 80A2 in the up-down direction of the support part 80A (refer to FIG. 1).

Further, in the side view, a part of the trigger 30 of the housing 20 is disposed at a position overlapping with the support part 80A in the up-down direction (refer to FIG. 3). In other words, when viewed from the left-right direction, a part of the trigger 30 is disposed within the range of the width dimension A of the support part 80A and extends in the front-rear direction. In other words, when viewed from the front-rear direction, a part of the trigger 30 and the support part 80A overlap with each other (refer to FIG. 3).

(Regarding controller 90) As shown in FIG. 2, the controller 90 is accommodated in the rear end part of the motor housing part 20B of the housing 20 and is held by the housing 20. The trigger switch 32, the sub-trigger switch 36, the motor 40, and the lifter detection switch 58 are electrically connected to the controller 90. The controller 90 detects the initial position of the lifter 55 based on a detection signal of the lifter detection switch 58. Further, the controller 90 performs drive control on the motor 40 based on output signals from the trigger switch 32, the sub-trigger switch 36, and the lifter detection switch 58. With the controller 90 forward-driving the motor 40, the lifter 55 (blade 60) moves toward the front side. With the controller 90 reverse-driving the motor 40, the lifter 55 (blade 60) moves toward the rear side.

Further, the controller 90 reverse-drives the motor 40 when the operation of the trigger 30 is released during forward drive of the motor 40 and the trigger switch 32 switches from on to off. Furthermore, the controller 90 includes a motor drive detection part 90A that detects a number of revolutions of the drive shaft 40A of the motor 40. The controller 90 detects how many revolutions the motor 40 has made from the initial position according to the detection signal from the motor drive detection part 90A. Accordingly, the controller 90 detects the processing position of the lifter 55 (blade 60) based on the number of revolutions of the motor 40 starting from the initial position of the lifter 55. Furthermore, the controller 90 stops drive of the motor 40 upon detecting the processing position of the lifter 55 (blade 60).

(Regarding position of center of gravity of electric cutting machine 10) Next, a position of a center of gravity G1 of the electric cutting machine 10 will be described. As shown in FIG. 1, the center of gravity G1 of the electric cutting machine 10 is located within the range of the width dimension B of the blade 60 in the side view. In other words, the center of gravity G1 is located at a position overlapping with the blade 60 in the up-down direction. Specifically, in the side view, the center of gravity G1 is located at a position overlapping with a lower end side portion of a substantially central part in the front-rear direction of the gripping part 20A2, on the rear side of the trigger 30. In other words, in the up-down direction, the center of gravity G1 is located at a position offset toward the lower side with respect to the central part 80A2 of the support part 80A. Further, as described above, in the side view, since the center of gravity G1 overlaps with the lower end side portion of the substantially central part in the front-rear direction of the gripping part 20A2, the rear part of the gripping part 20A2 is located on the outer side of a virtual circle CR that is centered on the central part 80A2 of the support part 80A and passes through the center of gravity G1. Furthermore, as shown in FIG. 3, the center of gravity G1 of the electric cutting machine 10 is located at a left-right central part of the electric cutting machine 10 in the left-right direction. In other words, when viewed from the front-rear direction, the center of gravity G1 overlaps with the blade 60 and the support part 80A.

(Action and effects) Next, effects of the electric cutting machine 10 of the present embodiment will be described while describing an action of the electric cutting machine 10.

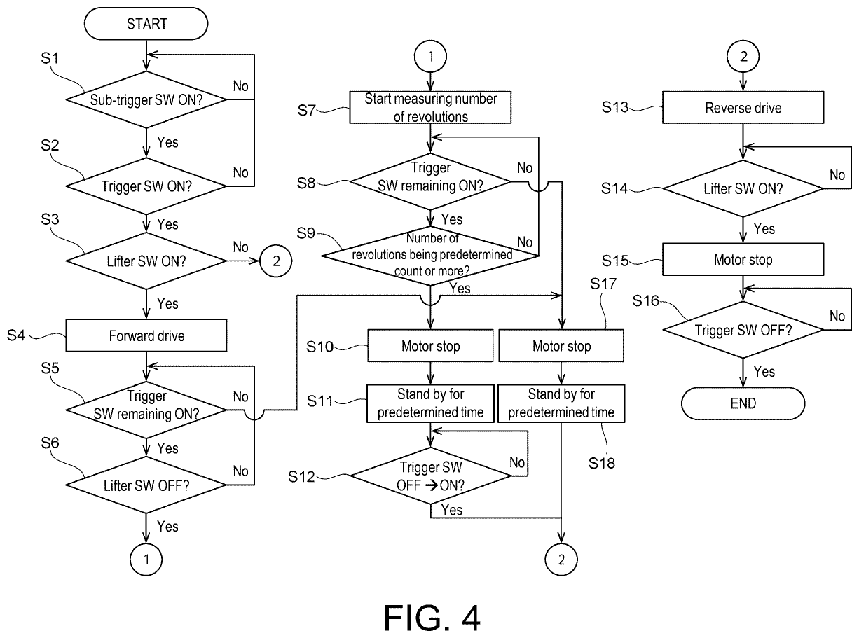

FIG. 4 shows a flowchart of the electric cutting machine 10. As shown in this figure, in the action of the electric cutting machine 10, in step 1 (S1), the controller 90 detects whether the sub-trigger switch 36 is on based on an output signal from the sub-trigger switch 36. In other words, the controller 90 determines whether the sub-trigger switch 36 has been operated. In the case where the sub-trigger switch 36 is not turned on in step 1 (in the case of “No” in step 1), the process returns to step 1. In the case where the sub-trigger switch 36 is turned on in step 1 (in the case of “Yes” in step 1), the process proceeds to step 2 (S2).

In step 2, based on an output signal from the trigger switch 32, it is detected whether the trigger switch 32 is on. In other words, the controller 90 determines whether the trigger 30 has been operated in the on-state of the sub-trigger switch 36. In the case where the trigger switch 32 is not turned on in step 2 (in the case of “No” in step 2), the process returns to step 1. In the case where the trigger switch 32 is turned on in step 2 (in the case of “Yes” in step 2), the process proceeds to step 3 (S3). From step 3 onward, even if the sub-trigger switch 36 switches from on to off, the action of the electric cutting machine 10 continues.

In step 3, the controller 90 detects whether the lifter detection switch 58 is turned on based on an output signal from the lifter detection switch 58. In other words, the controller 90 determines whether the lifter 55 is disposed at the initial position. In the case where the lifter detection switch 58 is on in step 3 (in the case of “Yes” in step 3), the process proceeds to step 4 (S4).

In step 4, the controller 90 forward-drives the motor 40. In other words, upon detecting the initial position of the lifter 55, the controller 90 forward-drives the motor 40. Accordingly, the lifter 55 and the blade 60 move toward the front side (outbound path side), and the blade 60 approaches the workpiece W. After the processing of step 4, the process proceeds to step 5 (S5).

In step 5, the controller 90 detects whether the on-state of the trigger switch 32 is continuing based on the output signal from the trigger switch 32. In other words, the controller 90 determines whether the operation on the trigger 30 is continuing. In the case where the on-state of the trigger switch 32 is continuing in step 5 (in the case of “Yes” in step 5), the process proceeds to step 6 (S6).

In step 6, the controller 90 detects whether the lifter detection switch 58 has switched from on to off based on the output signal from the lifter detection switch 58. In the case where the lifter detection switch 58 has switched to off in step 6 (in the case of “Yes” in step 6), the process proceeds to step 7 (S7). In other words, in the present embodiment, the position of the lifter 55 at which the lifter detection switch 58 has switched from on to off is taken as a starting point at the initial position of the lifter 55 moving in an outbound path (hereinafter, this position of the lifter 55 will be referred to as an initial starting point position), and in step 6, the controller 90 detects the initial starting point position of the lifter 55. On the other hand, in the case where the lifter detection switch 58 has not switched to off in step 6 (in the case of “No” in step 6), the process returns to step 5. In other words, in the case where the lifter 55 moving in the outbound path at the initial position has not reached the initial starting point position, the process returns to step 5.

In step 7, the controller 90 starts measuring a number of revolutions of the motor 40. Specifically, the controller 90 starts measuring (counting) the number of revolutions of the motor 40 based on a signal from the motor drive detection part 90A. After the processing of step 7, the process proceeds to step 8 (S8).

In step 8, the controller 90 detects whether the on-state of the trigger switch 32 is continuing based on the output signal from the trigger switch 32. In other words, the controller 90 determines whether the operation on the trigger 30 is continuing. In the case where the on-state of the trigger switch 32 is continuing in step 8 (in the case of “Yes” in step 8), the process proceeds to step 9 (S9).

In step 9, the controller 90 determines whether the number of revolutions of the motor 40 has become a predetermined number of revolutions or more. In other words, the controller 90 determines whether the lifter 55 has reached the processing position. In the case where the number of revolutions of the motor 40 is not the predetermined number of revolutions or more in step 9 (in the case of “No” in step 9), the process returns to step 8. In the case where the number of revolutions of the motor 40 is the predetermined number of revolutions or more in step 9 (in the case of “Yes” in step 9), the process proceeds to step 10 (S10).

In step 10, the controller 90 stops the forward drive of the motor 40. After the processing of step 10, the process proceeds to step 11 (S11).

In step 11, the motor 40 is set to a standby state. In other words, after stop of the forward drive of the motor 40, the motor 40 is set to a standby state without a drive control on the motor 40 performed by the controller 90. After the processing of step 11, the process proceeds to step 12 (S12). Specifically, after stop of the forward drive of the motor 40, the process proceeds to step 12 after a predetermined time has elapsed.

In step 12, it is detected whether the trigger switch 32 is on based on the output signal from the trigger switch 32. In the case where the trigger switch 32 is not turned on in step 12 (in the case of “No” in step 12), the process returns to step 12. In the case where the trigger switch 32 is turned on in step 12 (in the case of “Yes” in step 12), the process proceeds to step 13 (S13). In step 13, the controller 90 reverse-drives the motor 40. Accordingly, the lifter 55 and

the blade 60 move toward the rear side (return path side) and separate from the workpiece W. In other words, the lifter 55 and the blade 60 reverse at the processing position, and a return path movement of the lifter 55 and the blade 60 begins. After the processing of step 13, the process proceeds to step 14 (S14).

In step 14, the controller 90 detects whether the lifter detection switch 58 is turned on based on the output signal from the lifter detection switch 58. In other words, the controller 90 determines whether the lifter 55 has reached the initial position. In the case where the lifter detection switch 58 is not on in step 14 (in the case of “No” in step 14), the process returns to step 14. On the other hand, in the case where the lifter detection switch 58 is on in step 14 (in the case of “Yes” in step 14), the process proceeds to step 15 (S15).

In step 15, the reverse drive of the motor 40 performed by the controller 90 is stopped. Accordingly, the lifter 55 stops at the initial position. After the processing of step 15, the process proceeds to step 16 (S1).

In step 16, the controller 90 detects whether the trigger switch 32 has switched from on to off based on the output signal from the trigger switch 32. In other words, the controller 90 detects whether the operation on the trigger 30 has been released. In the case where the trigger switch 32 is not off in step 16 (in the case of “No” in step 16), the process returns to step 16. On the other hand, in the case where the trigger switch 32 is off in step 16 (in the case of “Yes” in step 16), the action of the electric cutting machine 10 is ended since the operation on the trigger 30 has been released.

In the case where the lifter detection switch 58 is not on in step 3 (in the case of “No” in step 3), the process proceeds to step 13. In other words, in this case, since the lifter 55 has not returned to the initial position at the start of the action of the electric cutting machine 10, the process proceeds to step 13 to return the lifter 55 to the initial position.

Further, in the case where the on-state of the trigger switch 32 is not continuing in step 5 and step 8 (in the case of “No” in step 5 and step 8), the process proceeds to step 17. In step 17, the controller 90 stops the forward drive of the motor 40, and after stop of the forward drive of the motor 40, the process proceeds to step 18. In step 18, similar to step 11, the motor 40 is set to the standby state, and after the standby state of the motor 40, the process proceeds to step 13. In other words, this is a case where the operator's operation on the trigger 30 is released during the outbound path movement of the lifter 55. Thus, the controller 90 stops the forward drive of the motor 40, and after a predetermined time has elapsed, reverse-drives the motor 40 to return the lifter 55 to the initial position.

In addition, when performing a cutting processing on a workpiece W serving as a light gauge steel fixed to a ceiling and the like, an operator located on a vertically lower side of the workpiece W sets the electric cutting machine 10 to an upright posture (a posture in a state in which the front-rear direction of the electric cutting machine 10 is aligned with the vertical direction such that the head part 80 becomes a vertically upper end part of the electric cutting machine 10) and disposes the electric cutting machine 10 on a vertically lower side of the workpiece W. Then, the workpiece W is inserted between the blade holder 72 and the head part 80, and is disposed on the vertically lower side of the head part 80. In this state, the workpiece W is inserted into the support part 80A of the head part 80 and is set to the head part 80. In other words, the workpiece W is engaged with the support part 80A of the head part 80, creating a state in which the electric cutting machine 10 is suspended from the workpiece W.

In this case, in the electric cutting machine 10, in the side view, the center of gravity G1 of the electric cutting machine 10 is located at a position overlapping with the blade 60 in the up-down direction of the electric cutting machine 10. In other words, in the side view, the center of gravity G1 of the electric cutting machine 10 is located within the range of the width dimension B of the blade 60 in the up-down direction. Thus, in the upright posture of the electric cutting machine 10, the center of gravity G1 of the electric cutting machine 10 is located on the vertically lower side of the blade 60 for cutting the workpiece W. Accordingly, operability of the electric cutting machine 10 can be improved.

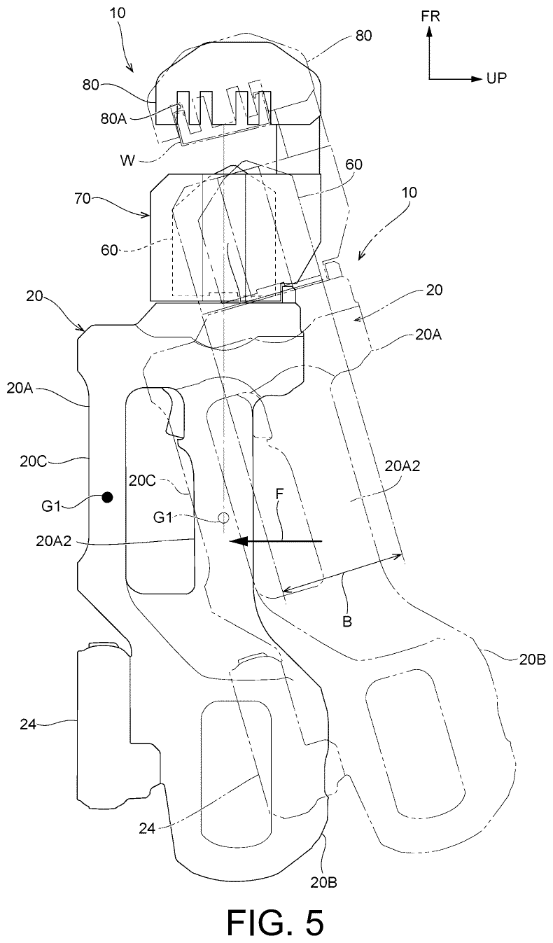

In other words, if the center of gravity G1 of the electric cutting machine 10 is located outside the range of the width dimension B of the blade 60 in the up-down direction (hereinafter, this electric cutting machine will be referred to as an electric cutting machine 10 of a comparative example), when set to the upright posture, since the center of gravity G1 becomes located on the vertically lower side of the workpiece W, the electric cutting machine 10 of the comparative example tends to tilt with respect to the vertical direction. For example, as indicated by a double-dot dash line in FIG. 5, in the case of the electric cutting machine 10 of the comparative example in which the center of gravity G1 is located at the handle guard 20C, the electric cutting machine 10 of the comparative example tilts such that the handle guard 20C is located on the vertically lower side of the workpiece W. Thus, it is required for the operator to apply a force F (see FIG. 5) in the horizontal direction to correct the posture of the electric cutting machine 10 of the comparative example to the upright posture indicated by a solid line. Accordingly, there is a risk that operability may decrease in case of the electric cutting machine 10 of the comparative example.

In contrast, in the case of the electric cutting machine 10 of the present embodiment, as described above, the center of gravity G1 is located within the range of the width dimension B of the blade 60 in the up-down direction. Thus, during the cutting processing in the upright posture, the electric cutting machine 10 naturally assumes an upright state along the vertical direction. Accordingly, tilt of the blade 60 with respect to the workpiece W can be suppressed. As a result, it is not required to correct the posture as in the electric cutting machine 10 of the comparative example. Thus, according to the electric cutting machine 10 of the present embodiment, operability can be improved.

Further, the gripping part 20A2 of the housing 20 is disposed at a position overlapping with the center of gravity G1 in the front-rear direction. In the present embodiment, in the side view, the center of gravity G1 overlaps with the lower end side portion at the substantially central part in the front-rear direction of the gripping part 20A2. In other words, in the present embodiment, the center of gravity G1 is located at a position overlapping with the gripping part 20A2 in the front-rear direction and the up-down direction. Thus, the gripping part 20A2, at which the center of gravity G1 is located, can be gripped to perform the cutting processing.

Further, a burden on the operator can be reduced for maintaining the upright posture state of the electric cutting machine 10 of the time when the operator grips the gripping part 20A2 and sets the electric cutting machine 10 to the upright posture. As a result, the workpiece W can be easily inserted between the blade holder 72 and the head part 80. According to the above, operability of the electric cutting machine 10 can be further improved.

Further, the gripping part 20A2 is disposed at a position overlapping with the center of gravity G1 in the front-rear direction, and is extended in the front-rear direction. Thus, for example, a good posture balance of the electric cutting machine 10 can be created when the operator grips the gripping part 20A2 of the electric cutting machine 10 in a horizontal posture (a posture in a state in which the front-rear direction of the electric cutting machine 10 is aligned with the horizontal direction). Accordingly, for example, transportability of the electric cutting machine 10 in the horizontal posture can be improved.

Further, the tip part 60B of the blade part 60A of the blade 60 is disposed at a position offset toward the upper side with respect to the central part 80A2 in the width direction of the support part 80A, and the center of gravity G1 is offset toward the lower side with respect to the central part 80A2 in the width direction of the support part 80A. Accordingly, it becomes easy to ensure a distance from the tip part 60B or the screw 61 (a connecting part between the blade 60 and the lifter 55) that receives a reaction force to the center of gravity G1. By configuring the position of the center of gravity away from the position at which the reaction force occurs, rotation of the electric cutting machine 10 can be suppressed when the reaction force occurs.

Further, the rear part of the gripping part 20A2 is located outside a virtual circle CR that is centered on the central part 80A2 in the width direction of the support part 80A and passes through the center of gravity G1. Accordingly, operability of the electric cutting machine 10 can be further improved. In other words, for example, when setting a workpiece W, which serves as a light gauge steel, to the electric cutting machine 10 in the upright posture, the workpiece W is set to be hooked to the support part 80A. At this time, due to the force F applied by the operator to the gripping part 20A2, a moment centered on the support part 80A may be generate for hooking. Thus, with the operator gripping the gripping part 20A2, which is more distant from the support part 80A than the center of gravity G1, the moment can be generated by a relatively small force F to set the workpiece W to be hooked to the support part 80A. Accordingly, operability of the electric cutting machine 10 can be further improved.

Further, the motor 40 is accommodated in the motor housing part 20B of the housing 20, and the motor 40 is disposed at a position offset to the upper side with respect to the central part 80A2 in the width direction of the support part 80A of the head part 80. Specifically, the housing 20 is extended in the front-rear direction, the gripping part 20A2 constitutes the front side portion of the housing 20, and the motor housing part 20B constitutes the rear part of the housing 20. Accordingly, the rear end part of the feed screw mechanism 50, which serves to cause the blade 60 to reciprocate by the drive force of the motor 40, and the front end part of the motor 40 can be disposed to overlap with each other in the front-rear direction and accommodated in the housing 20. Thus, the configuration can contribute to reduction in a body size of the electric cutting machine 10 in the front-rear direction.

Further, the battery mounting part 20D for mounting the battery 24 is provided at the motor housing part 20B, and the battery mounting part 20D is provided on the lower side of the motor 40. Furthermore, the battery terminal 22 for supplying power to the motor 40 is provided at the battery mounting part 20D. Accordingly, the battery 24 supplying power to the motor 40 can be mounted to the housing 20 while suppressing an increase in the body size of the electric cutting machine 10 in the front-rear direction.

Further, in the side view, the entire gripping part 20A2 is disposed at a position overlapping with the support part 80A in the up-down direction. In other words, the gripping part 20A2 is disposed on the rear side of the head part 80, and when viewed from the front-rear direction, the gripping part 20A2 and the support part 80A overlap with each other. Thus, when the electric cutting machine 10 is set to the upright posture, the gripping part 20A2 is disposed directly below the support part 80A in the vertical direction. Accordingly, when setting a workpiece W, which serves as a light gauge steel fixed to a ceiling and the like, to the electric cutting machine 10, the position of the support part 80A (head part 80) can be easily recognized. As a result, the operator gripping the gripping part 20A2 can easily bring the head part 80 closer to the workpiece W and set the workpiece W to the support part 80A of the head part 80. According to the above, operability of the electric cutting machine 10 can be effectively improved. Further, the trigger 30 is provided at the gripping part 20A2, and a part of the trigger 30 overlaps with the support part 80A when viewed from the front-rear direction. Accordingly, the trigger 30 can be operated with the operator's hand gripping the gripping part 20A2 while maintaining a state in which the operator's hand is located directly behind the support part 80A. Thus, operability of the electric cutting machine 10 can be further improved.

Further, the housing 20 includes the handle guard 20C extended in the front-rear direction, and the handle guard 20C is disposed on the lower side of the gripping part 20A2 and on the front side of the battery mounting part 20D. In other words, in the front-rear direction, the handle guard 20C is disposed at a position overlapping with the center of gravity G1. Accordingly, stabilization of a placement state of the electric cutting machine 10 can be achieved when the handle guard 20C is placed on the ground and the like with the electric cutting machine 10 in the horizontal posture. As a result, for example, stabilization of a storage state of the electric cutting machine 10 can be achieved. Further, it also becomes easy to perform a cutting work with the electric cutting machine 10 placed horizontally.

### Second Embodiment

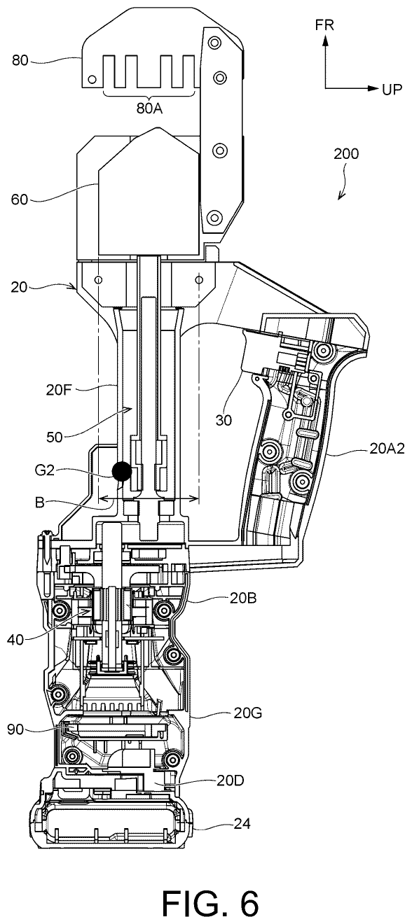

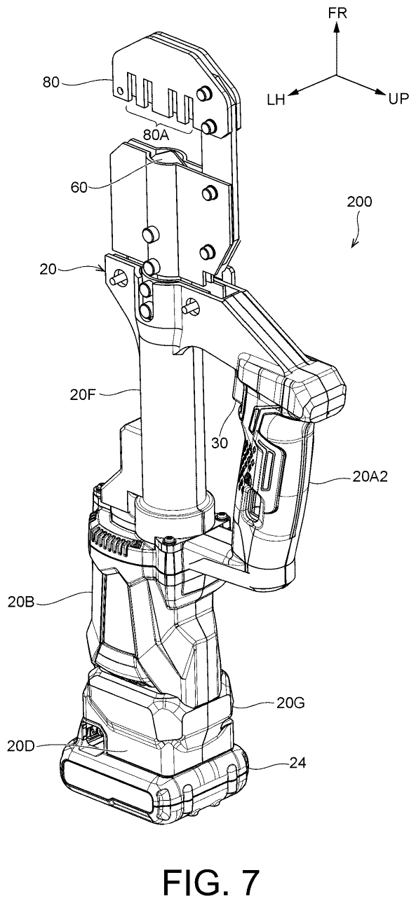

Next, an electric cutting machine 200 as a work machine of Second Embodiment will be described with reference to FIG. 6 and FIG. 7. The electric cutting machine 200 of Second Embodiment is configured similarly to the electric cutting machine 10 of

First Embodiment, except for the points described below. In FIG. 6 and FIG. 7, members configured similarly to those in the electric cutting machine 10 of First Embodiment will be labeled with the same reference signs.

In other words, in Second Embodiment, the handle guard 20C is omitted in the housing

20. A front-rear dimension of the housing 20 is set to be larger than in First Embodiment. The housing 20 includes a lifter housing part 20F constituting a front end part of the housing 20, a motor housing part 20B constituting a middle part in the front-rear direction of the housing 20, and a rear housing part 20G constituting a rear part of the housing 20. The lifter housing part 20F is formed into a substantially tubular shape extended in the front-rear direction, and a feed screw mechanism 50 is accommodated in the lifter housing part 20F. A motor 40 is accommodated in the motor housing part 20B, and the motor 40 is disposed at a position offset to the lower side with respect to a drive shaft 53 of the feed screw mechanism 50. A controller 90 is accommodated in the rear housing part 20G, and a battery mounting part 20D is provided at a rear end part of the rear housing part 20G.

A gripping part 20A2 is disposed on the upper side of the lifter housing part 20F and is

extended in the front-rear direction. Specifically, in a side view, the gripping part 20A2 is extended along a direction that is slightly inclined toward the upper side as it extends toward the front side. A front end part of the gripping part 20A2 is bent toward the lower side and is connected to a front end part of the lifter housing part 20F, and a rear end part of the gripping part 20A2 is bent toward the lower side and is connected to the motor housing part 20B. A trigger 30 protruding toward the lower side is provided at the front end part of the gripping part 20A2. In Second Embodiment, although the handle guard 20C is omitted in the housing 20, by being surrounded by the lifter housing part 20F and the gripping part 20A2, a periphery of the trigger 30 is protected as a result.

In Second Embodiment as well, in the side view, a center of gravity G2 of the electric cutting machine 200 is located at a location overlapping with a blade 60 and a support part 80A in the up-down direction of the electric cutting machine 200. Specifically, in the side view, the center of gravity G2 overlaps with the lifter housing part 20F, and is located within a range of a width dimension B of the blade 60 and within a range of a width dimension A of the support part 80A in the up-down direction. Thus, in an upright posture of the electric cutting machine 200, the center of gravity G2 of the electric cutting machine 200 is located on the vertically lower side of the blade 60 for cutting the workpiece W. Accordingly, similarly to First Embodiment, operability of the electric cutting machine 200 can be improved.

Further, in Second Embodiment as well, the gripping part 20A2 of the housing 20 is disposed at a position overlapping with the center of gravity G2 in the front-rear direction. Thus, the gripping part 20A2, which is disposed at a position substantially aligned with the center of gravity G2 in a longitudinal direction of the electric cutting machine 200 can be gripped to perform a cutting processing. Accordingly, operability of the electric cutting machine 200 can be further improved.

Further, in Second Embodiment as well, the gripping part 20A2 is disposed at a position overlapping with the center of gravity in the front-rear direction and is extended in the front-rear direction. Thus, for example, a good posture balance of the electric cutting machine 200 can be created when the operator grips the gripping part 20A2 of the electric cutting machine 200 in a horizontal posture. Accordingly, transportability of the electric cutting machine 200 in the horizontal posture can be improved.

### Third Embodiment

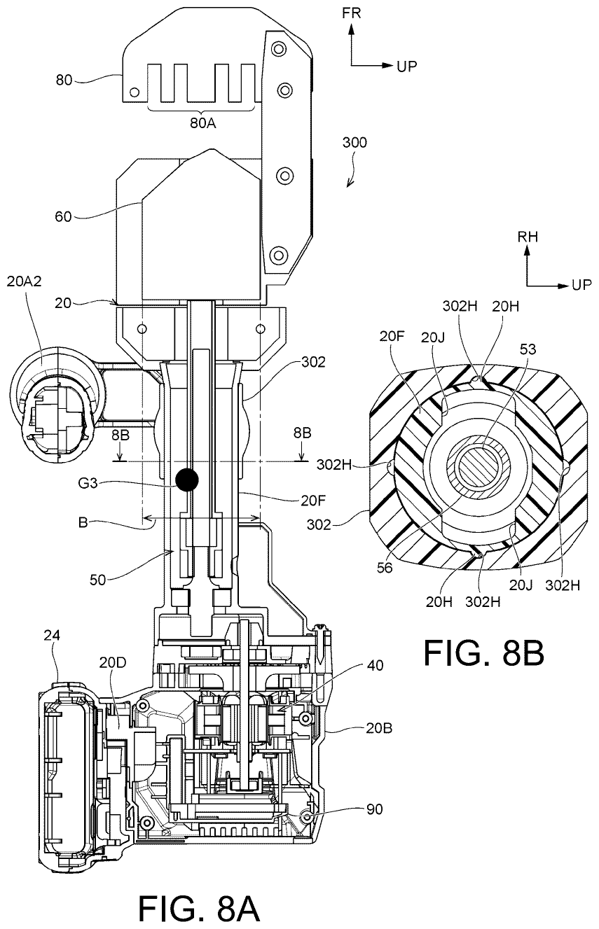

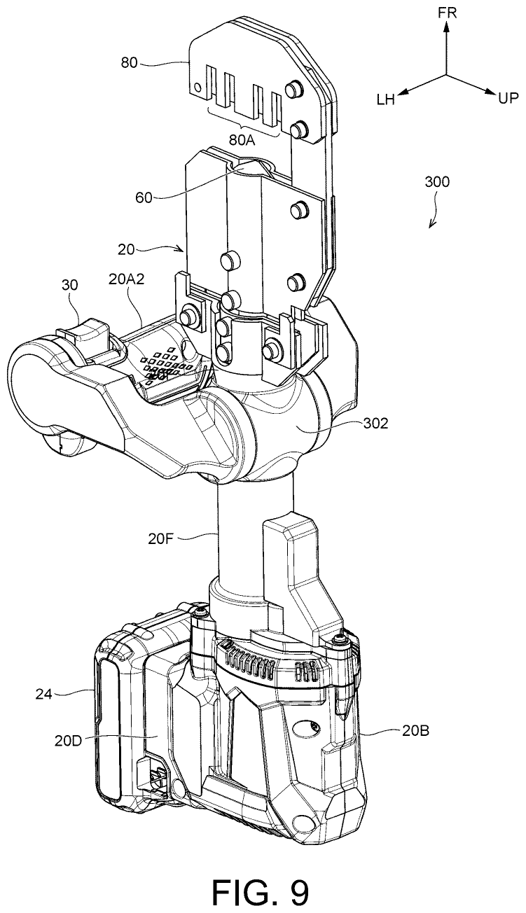

Next, an electric cutting machine 300 as a work machine of Third Embodiment will be described with reference to FIG. 8 and FIG. 9. FIG. 8 (A) shows a cross-sectional view similar to FIG. 2 and FIG. 6, and FIG. 8 (B) shows a schematic cross-sectional view at an 8B-8B line position in FIG. 8(A). The electric cutting machine 300 of Third Embodiment is configured similarly to the electric cutting machine 10 of First Embodiment, except for the points described below. In FIG. 8 and FIG. 9, members configured similarly to those in the electric cutting machine 10 of First Embodiment will be labeled with the same reference signs.

In other words, similar to Second Embodiment, in Third Embodiment, the handle guard 20C is omitted in the housing 20. The housing 20 includes a lifter housing part 20F similar to that in Second Embodiment, and a motor housing part 20B constituting a rear end part of the housing 20. The lifter housing part 20F constitutes a front part of the housing 20, and a feed screw mechanism 50 is accommodated in the lifter housing part 20F. A motor 40 is accommodated in the motor housing part 20B, and the motor 40 is disposed at a position offset to the upper side with respect to a drive shaft 53 of the feed screw mechanism 50. A battery mounting part 20D is provided at a lower end part of the motor housing part 20B, and a battery 24 mounted to the battery mounting part 20D is disposed on the lower side of the motor housing part 20B.

A gripping part 20A2 is disposed on the radially outer side of the lifter housing part 20F and is extended in a direction orthogonal to the front-rear direction (in the example shown in FIG. 9, the gripping part 20A2 is disposed on the lower side of the lifter housing part 20F and is extended in the left-right direction). The gripping part 20A2 is connected to the lifter housing part 20F by a connecting part 302 and is configured to be rotatable in a circumferential direction of the lifter housing part 20F. Specifically, the connecting part 302 is provided on the radially outer side of the lifter housing part 20F, and both longitudinal end parts of the gripping part 20A2 are bent toward the lifter housing part 20F side and are connected to the connecting part 302.

Accordingly, the gripping part 20A2 is extended in a direction orthogonal to the front-rear direction on the radially outer side of the lifter housing part 20F and is connected rotatably in the circumferential direction of the lifter housing part 20F. A trigger 30 is provided at one end part in the longitudinal direction of the gripping part 20A2, and the trigger 30 protrudes toward the upper side from the gripping part 20A2. As shown in FIG. 8(B), two protrusions 20H and two thinned parts 20J are provided at the lifter housing part 20F respectively at positions 180 degrees apart as rotation positions. Further, recesses 302H are provided on an inner surface of the connecting part 302 at 90-degree intervals. Rotation positions of the gripping part 20A2 are fixed by engagement between the protrusions 20H and the recesses 302H. The protrusion 20H has a curved surface, and a portion supporting the protrusion 20H is elastically deformable due to the thinned part 20J. Thus, upon applying a torque of a predetermined value or more to the gripping part 20A2, the protrusion 20H retreats to the radially inner side and disengages from the recess 302H. Upon continuing to rotate the gripping part 20A2 in this manner, the protrusion 20H fits into the recess 302H at a position 90 degrees apart, and the rotation position of the gripping part 20A2 is fixed. The gripping part 20A2 is configured to be rotatable within a predetermined angular range (270 degrees) with respect to the lifter housing part 20F by an unillustrated locking structure. In other words, the gripping part 20A2 is capable of selecting four rotation positions at 90-degree intervals. The torque on the gripping part 20A2 required for a rotation position change is adjustable by a thinning amount of the thinned part 20J. In this manner, in Second Embodiment, the position of the gripping part 20A2 is configured to be changeable, and operability can be improved.

In Third Embodiment as well, in a side view, a center of gravity G3 of the electric cutting machine 300 is located at a position overlapping with a blade 60 and a support part 80A in the up-down direction of the electric cutting machine 200. Specifically, in the side view, the center of gravity G3 overlaps with the lifter housing part 20F, and is located within a range of a width dimension B of the blade 60 and within a range of a width dimension A of the support part 80A in the up-down direction. Thus, in an upright posture of the electric cutting machine 300, the center of gravity G3 of the electric cutting machine 300 is located on the vertically lower side of the blade 60 for cutting the workpiece W. Accordingly, similarly to First Embodiment, operability of the electric cutting machine 300 can be improved. Also, this position relationship of center of gravity is configured to remain unchanged even if the rotation position of the gripping part 20A2 is changed.

### Fourth Embodiment

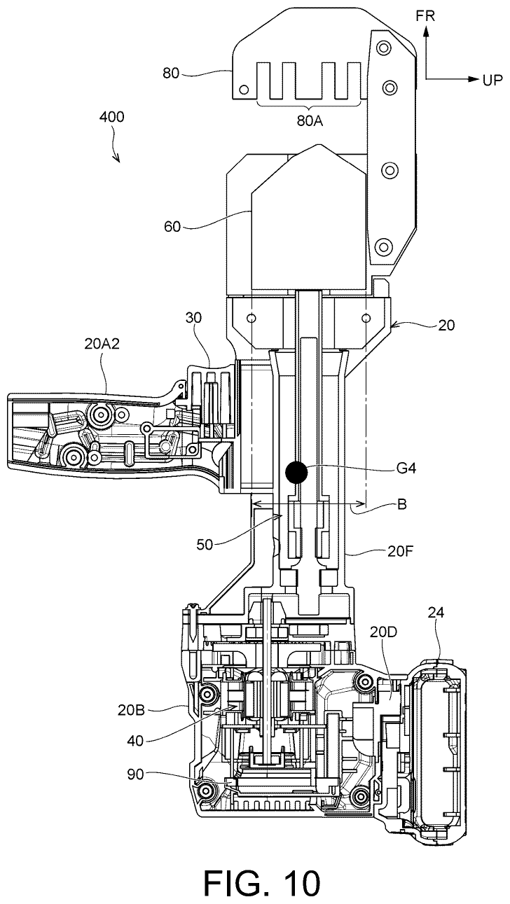

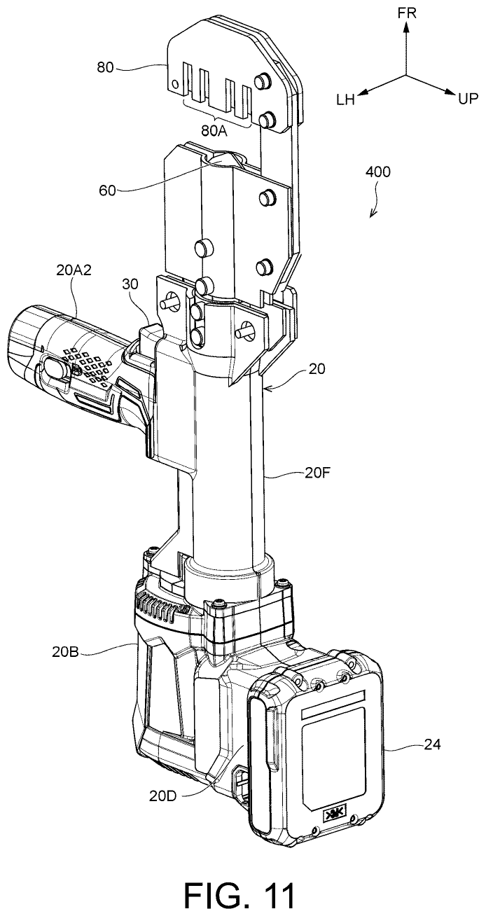

Next, an electric cutting machine 400 as a work machine of Fourth Embodiment will be described with reference to FIG. 10 and FIG. 11. The electric cutting machine 400 of Fourth Embodiment is configured similarly to the electric cutting machine 10 of First Embodiment, except for the points described below. In FIG. 10 and FIG. 11, members configured similarly to those in the electric cutting machine 10 of First Embodiment will be labeled with the same reference signs.

In other words, similar to Second Embodiment, in Fourth Embodiment, the handle guard 20C is omitted in the housing 20. The housing 20 includes a lifter housing part 20F similar to that in Second Embodiment, and a motor housing part 20B constituting a rear end part of the housing 20. The lifter housing part 20F constitutes a front part of the housing 20, and a feed screw mechanism 50 is accommodated in the lifter housing part 20F. A motor 40 is accommodated in the motor housing part 20B, and similarly to Second Embodiment, the motor 40 is disposed at a position offset to the lower side with respect to a drive shaft 53 of the feed screw mechanism 50. A battery mounting part 20D is provided at an upper end part of the motor housing part 20B, and a battery 24 mounted to the battery mounting part 20D is disposed on the upper side of the motor housing part 20B.

A gripping part 20A2 is extended in the up-down direction and extends toward the lower side from a front end side portion of the lifter housing part 20F. In other words, the gripping part 20A2 extends toward the radially outer side of the lifter housing part 20F from the front end side portion of the lifter housing part 20F. A battery 24 is not disposed on the rear side of the gripping part 20A2, and the gripping part 20A2 extends toward a side opposite to a protruding direction of the battery 24 with respect to the housing 20. A trigger 30 protruding toward the front side is provided at an upper end part of the gripping part 20A2.

In Fourth Embodiment as well, in a side view, a center of gravity G4 of the electric cutting machine 400 is located at a position overlapping with a blade 60 and a support part 80A in the up-down direction of the electric cutting machine 400. Specifically, in the side view, the center of gravity G4 overlaps with the lifter housing part 20F, and is located within a range of a width dimension B of the blade 60 and within a range of a width dimension A of the support part 80A in the up-down direction. Thus, in an upright posture of the electric cutting machine 400, the center of gravity G4 of the electric cutting machine 400 is located on the vertically lower side of the blade 60 for cutting the workpiece W. Accordingly, similarly to First Embodiment, operability of the electric cutting machine 400 can be improved.

Further, in Fourth Embodiment, the gripping part 20A2 of the housing 20 is disposed at a position overlapping with the center of gravity G4 in the front-rear direction. Thus, the gripping part 20A2, which is disposed at a position substantially aligned with the center of gravity G4 in the longitudinal direction of the electric cutting machine 400, can be gripped to perform a cutting processing. Accordingly, operability of the electric cutting machine 400 can be further improved.

### Fifth Embodiment

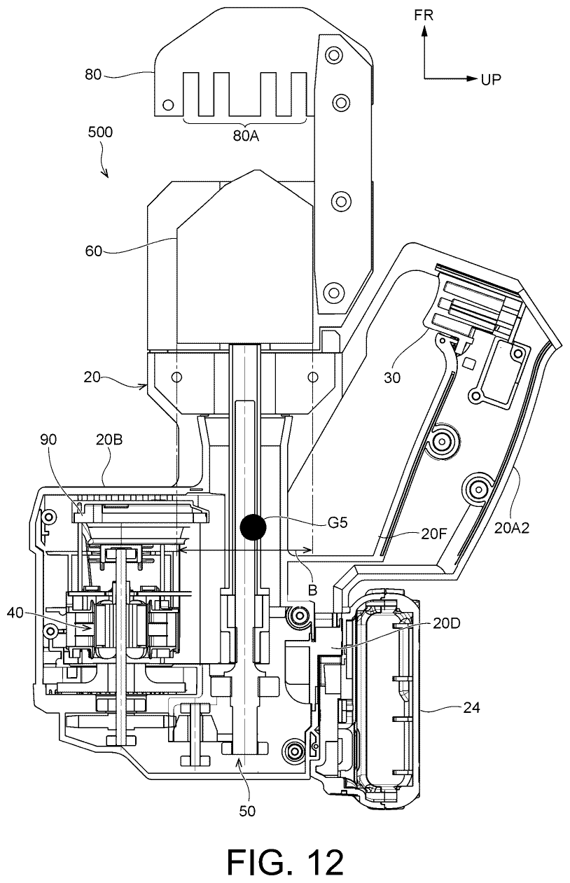

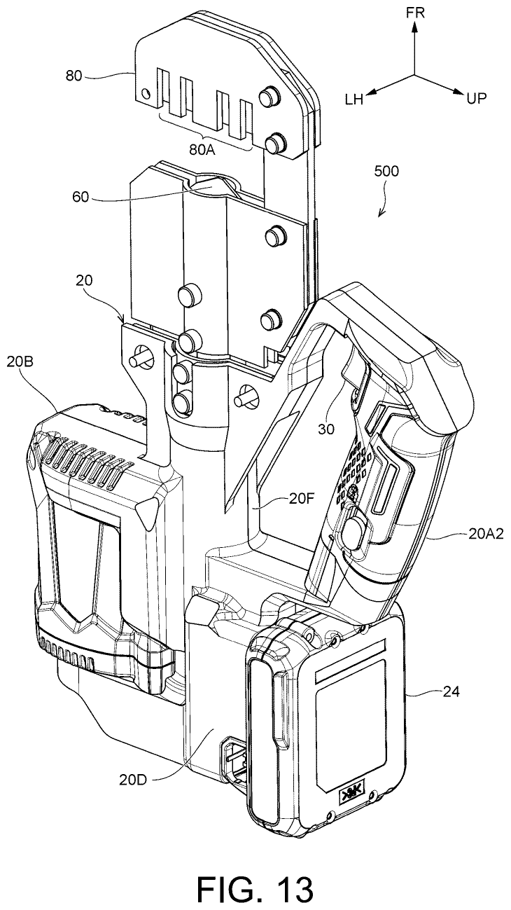

Next, an electric cutting machine 500 as a work machine of Fifth Embodiment will be described with reference to FIG. 12 and FIG. 13. The electric cutting machine 500 of Fifth Embodiment is configured similarly to the electric cutting machine 10 of First Embodiment, except for the points described below. In FIG. 12 and FIG. 13, members configured similarly to those in the electric cutting machine 10 of First Embodiment will be labeled with the same reference signs.

In other words, similar to Second Embodiment, in Fifth Embodiment, the handle guard 20C is omitted in the housing 20. In Fifth Embodiment, a front-rear dimension of the housing 20 is set to be smaller than that in First Embodiment. The housing 20 includes a lifter housing part 20F similar to that in Second Embodiment, and a motor housing part 20B disposed on the lower side of the lifter housing part 20F. A feed screw mechanism 50 is accommodated in the lifter housing part 20F. A motor 40 and a controller 90 are accommodated in the motor housing part 20B, and the motor 40 is disposed in parallel on the lower side of the feed screw mechanism 50. The controller 90 is disposed on the front side of the motor 40. A battery mounting part 20D is provided on the upper side of a rear end part of the lifter housing part 20F, and a battery 24 mounted to the battery mounting part 20D is disposed on the upper side of the motor housing part 20B.

A gripping part 20A2 is extended in the front-rear direction and is disposed on the upper side of the lifter housing part 20F and on the front side of the battery 24. Specifically, the gripping part 20A2 extends along a direction that is inclined toward the upper side as it extends toward the front side in a side view. A front end part of the gripping part 20A2 is bent toward a diagonally lower side and is connected to a front end part of the lifter housing part 20F. A rear end part of the gripping part 20A2 is bent toward the lower side and is connected to a middle part in the front-rear direction of the lifter housing part 20F. A trigger 30 protruding toward the lower side is provided at the front end part of the gripping part 20A2.

In Fifth Embodiment as well, in the side view, a center of gravity G5 of the electric cutting machine 500 is located at a position overlapping with a blade 60 and a support part 80A in the up-down direction of the electric cutting machine 500. Specifically, in the side view, the center of gravity G5 overlaps with the lifter housing part 20F, and is located within a range of a width dimension B of the blade 60 and within a range of a width dimension A of the support part 80A in the up-down direction. Thus, in an upright posture of the electric cutting machine 500, the center of gravity G5 of the electric cutting machine 500 is located on the vertically lower side of the blade 60 for cutting the workpiece W. Accordingly, similarly to First Embodiment, operability of the electric cutting machine 500 can be improved.

Further, in Fifth Embodiment as well, the gripping part 20A2 of the housing 20 is disposed at a position overlapping with the center of gravity G5 in the front-rear direction. Thus, the gripping part 20A2, which is disposed at a position substantially aligned with the center of gravity G5 in the longitudinal direction of the electric cutting machine 500, can be gripped to perform a cutting processing. Accordingly, operability of the electric cutting machine 500 can be further improved.

Further, in Fifth Embodiment, the motor housing part 20B is disposed on the lower side of the lifter housing part 20F, and the gripping part 20A2 and the battery 24 are disposed on the upper side of the lifter housing part 20F and are arranged in a row in the front-rear direction. Accordingly, reduction in a body size of the electric cutting machine 500 in the front-rear direction can be achieved.

### Sixth Embodiment

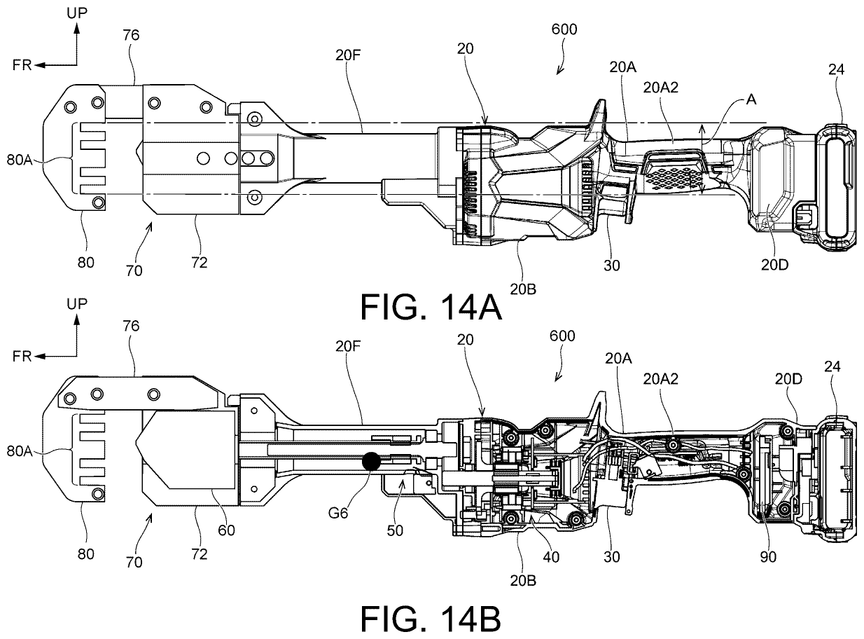

Next, an electric cutting machine 600 as a work machine of Sixth Embodiment will be described with reference to FIGS. 14(A) and (B). The electric cutting machine 600 of Sixth Embodiment is configured similarly to the electric cutting machine 10 of First Embodiment, except for the points described below. In FIGS. 14(A) and (B), members configured similarly to those in the electric cutting machine 10 of First Embodiment will be labeled with the same reference signs.

Specifically, in Sixth Embodiment, the handle guard 20C is omitted in the housing 20. A front-rear dimension of the housing 20 is set to be larger than that in First Embodiment. The housing 20 includes a lifter housing part 20F constituting a front end part of the housing 20, a motor housing part 20B constituting a middle part in the front-rear direction of the housing 20, and a handle housing part 20A constituting a rear part of the housing 20. The lifter housing part 20F is formed into a substantially tubular shape extended in the front-rear direction, and a feed screw mechanism 50 is accommodated in the lifter housing part 20F. motor 40 is accommodated in the motor housing part 20B, and a lower part of the motor housing part 20B protrudes more downward than the lifter housing part 20F.

A gripping part 20A2 constitutes a front part of the handle housing part 20A and is extended in the front-rear direction. A lower part at a rear end part of the handle housing part 20A protrudes more downward than the handle housing part 20A, and a battery mounting part 20D is provided at the rear end part of the handle housing part 20A. A battery 24 mounted to the battery mounting part 20D constitutes a rear end part of the electric cutting machine 200. Further, a controller 90 is accommodated in the rear end part of the handle housing part 20A. A trigger 30 is provided at a front end part of the gripping part 20A2, and the trigger 30 protrudes toward the lower side from the front end part of the gripping part 20A2. In other words, in the case of the electric cutting machine 600 of Sixth Embodiment, the housing 20 protrudes more rearward than in First Embodiment, and the gripping part 20A2 is disposed on the rear side of the motor 40.

In Sixth Embodiment as well, in a side view, a center of gravity G6 of the electric cutting machine 600 is located at a position overlapping with a blade 60 and a support part 80A in the up-down direction of the electric cutting machine 600. Specifically, in the side view, the center of gravity G6 overlaps with the lifter housing part 20F, and is located within a range of a width dimension B of the blade 60 and within a range of a width dimension A of the support part 80A in the up-down direction. Thus, in an upright posture of the electric cutting machine 200, the center of gravity G6 of the electric cutting machine 200 is located on the vertically lower side of the blade 60 for cutting the workpiece W. Accordingly, similarly to First Embodiment, operability of the electric cutting machine 600 can be improved.

Furthermore, in Sixth Embodiment as well, the gripping part 20A2 gripped by the operator is disposed on the rear side of the head part 80 and overlaps with the support part 80A of the head part 80 when viewed from the front-rear direction. Specifically, when viewed from the left-right direction, the gripping part 20A2 is disposed within the range of the width dimension A of the support part 80A and extends in the front-rear direction. In other words, when viewed from the left-right direction, the gripping part 20A2 is at a same position as the support part 80A in the up-down direction. Thus, similarly to First Embodiment, when setting a workpiece W, which serves as a light gauge steel fixed to a ceiling and the like, to the electric cutting machine 600, the gripping part 20A2 is disposed on the vertically lower side of the support part 80A. As a result, the workpiece W can be easily set to the support part 80A of the head part 80. According to the above, operability of the electric cutting machine 600 can be improved.

Further, in Sixth Embodiment as well, the trigger 30 is provided at the front end part of the gripping part 20A2, and a part of the trigger 30 overlaps with the support part 80A when viewed from the front-rear direction. Specifically, when viewed from the left-right direction, a part of the trigger 30 is disposed within the range of the width dimension A of the support part 80A. Accordingly, similarly to First Embodiment, the trigger 30 can be operated with the operator's hand gripping the gripping part 20A2 while maintaining a state in which the operator's hand is located on the rear side of the support part 80A. Thus, operability of the electric cutting machine 600 can be further improved.

Further, in Sixth Embodiment, the housing 20 is extended in the front-rear direction, and the motor housing part 20B, the gripping part 20A2, and the battery mounting part 20D are arranged in a row in the front-rear direction. Further, the gripping part 20A2 is disposed at a rear part (more rearward than the central part in the front-rear direction) of the housing 20. Thus, the gripping part 20A2 can be set on a rear end side of the electric cutting machine 600 while extending the body size of the electric cutting machine 600 in the front-rear direction. Accordingly, when setting a workpiece W, which serves as a light gauge steel fixed to a ceiling and the like, to the electric cutting machine 10, the gripping part 20A2 can be positioned on the vertically lower side compared to First Embodiment. As a result, a lifting amount of the electric cutting machine 600 lifted by the operator can be reduced. Accordingly, operability of the electric cutting machine 600 can be further improved.

### Seventh Embodiment

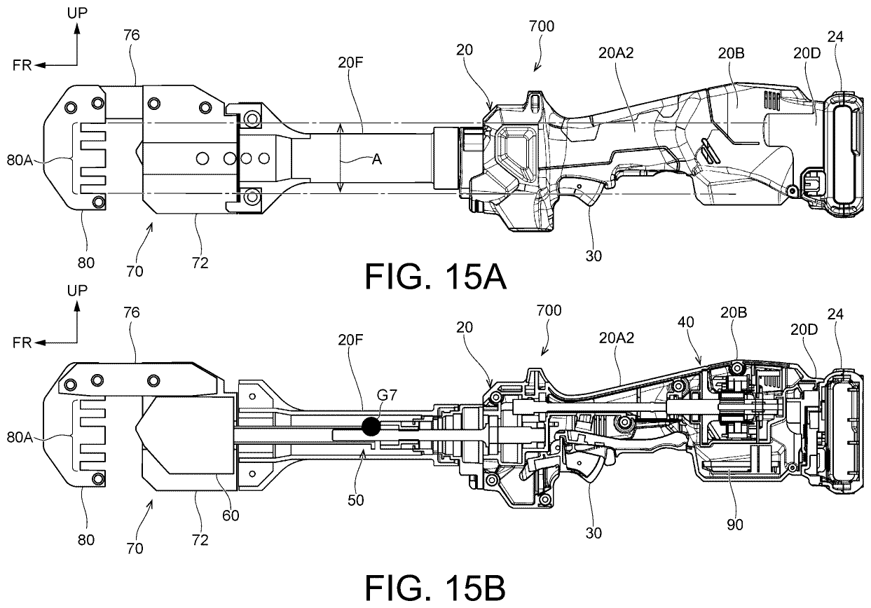

Next, an electric cutting machine 700 as a work machine of Seventh Embodiment will be described with reference to FIGS. 15(A) and (B). The electric cutting machine 700 of Seventh Embodiment is configured similarly to the electric cutting machine 10 of First Embodiment, except for the points described below. In FIGS. 15(A) and (B), members configured similarly to those in the electric cutting machine 10 of First Embodiment will be labeled with the same reference signs.

Specifically, similar to Sixth Embodiment, in Seventh Embodiment, the handle guard 20C is omitted in the housing 20, and a front-rear dimension of the housing 20 is set to be larger than in First Embodiment. The housing 20 includes a lifter housing part 20F similar to that in Sixth Embodiment, a gripping part 20A2 constituting a middle part in the front-rear direction of the housing 20, and a motor housing part 20B constituting a rear end part of the housing 20. The lifter housing part 20F constitutes a front end part of the housing 20, and a feed screw mechanism 50 is accommodated in the lifter housing part 20F. A motor 40 is accommodated in the motor housing part 20B. A battery mounting part 20D is provided at a rear end part of the motor housing part 20B, and a battery 24 mounted to the battery mounting part 20D constitutes a rear end part of the electric cutting machine 700. Accordingly, in Seventh Embodiment, the lifter housing part 20F, the gripping part 20A2, the motor housing part 20B, and the battery mounting part 20D are arranged in a row in the front-rear direction.

In Seventh Embodiment as well, in a side view, a center of gravity G7 of the electric cutting machine 700 is located at a position overlapping with a blade 60 and a support part 80A in the up-down direction of the electric cutting machine 700. Specifically, in the side view, the center of gravity G7 overlaps with the lifter housing part 20F, and is located within a range of a width dimension B of the blade 60 and within a range of a width dimension A of the support part 80A in the up-down direction. Thus, in an upright posture of the electric cutting machine 700, the center of gravity G7 of the electric cutting machine 700 is located on the vertically lower side of the blade 60 for cutting the workpiece W. Accordingly, similarly to First Embodiment, operability of the electric cutting machine 700 can be improved.

Furthermore, in Seventh Embodiment as well, the gripping part 20A2 gripped by the operator is disposed on the rear side of the head part 80 and overlaps with the support part 80A of the head part 80 when viewed from the front-rear direction. Specifically, when viewed from the left-right direction, substantially the entire gripping part 20A2 is disposed within the range of the width dimension A of the support part 80A and extends in the front-rear direction. In other words, when viewed from the left-right direction, substantially the entire gripping part 20A2 is at a same position as the support part 80A in the up-down direction. Thus, similarly to First Embodiment, when setting a workpiece W, which serves as a light gauge steel fixed to a ceiling and the like, to the electric cutting machine 700, the gripping part 20A2 is disposed on the vertically lower side of the support part 80A. As a result, the workpiece W can be easily set to the support part 80A of the head part 80. According to the above, operability of the electric cutting machine 700 can be improved.

Further, in Seventh Embodiment as well, a trigger 30 is provided at a front end part of the gripping part 20A2, and a part of the trigger 30 overlaps with the support part 80A when viewed from the front-rear direction. Specifically, when viewed from the left-right direction, a part of the trigger 30 is disposed within the range of the width dimension A of the support part 80A. Accordingly, similarly to First Embodiment, the trigger 30 can be operated with the operator's hand gripping the gripping part 20A2 while maintaining a state in which the operator's hand is located on the rear side of the support part 80A. Thus, operability of the electric cutting machine 700 can be further improved.

Further, in Seventh Embodiment, the housing 20 is extended in the front-rear direction, and the lifter housing part 20F, the gripping part 20A2, the motor housing part 20B, and the battery mounting part 20D are arranged in a row in the front-rear direction. Further, the gripping part 20A2 is disposed at a rear part (more rearward than the central part in the front-rear direction) of the housing 20. Thus, similarly to Sixth Embodiment, the gripping part 20A2 can be set on a rear end side of the electric cutting machine 700 while extending a body size of the electric cutting machine 700 in the front-rear direction. Accordingly, when setting a workpiece W, which serves as a light gauge steel fixed to a ceiling and the like, to the electric cutting machine 700, the gripping part 20A2 can be positioned on the vertically lower side compared to First Embodiment. As a result, a lifting amount of the electric cutting machine 700 lifted by the operator can be reduced. Accordingly, operability of the electric cutting machine 700 can be further improved.

### Eighth Embodiment

Next, an electric cutting machine 800 as a work machine of

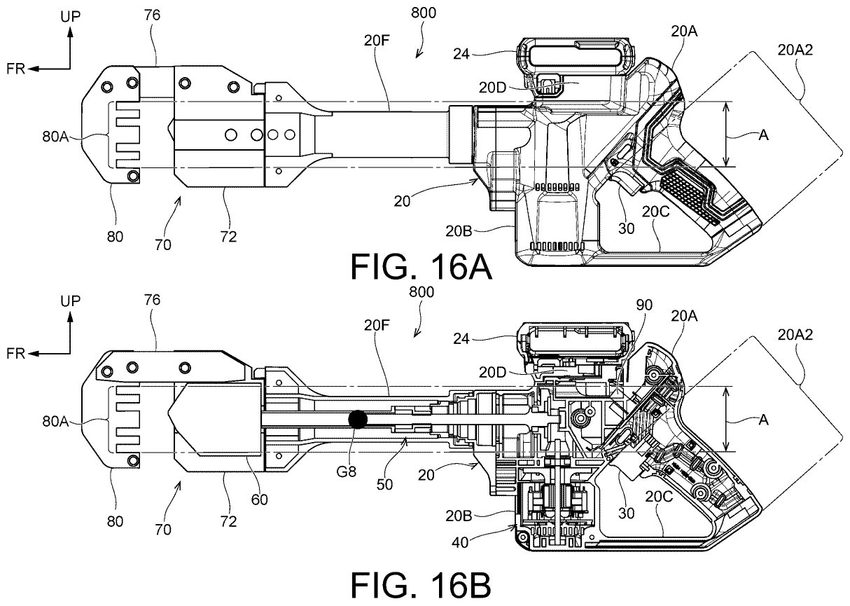

Eighth Embodiment will be described with reference to FIGS. 16(A) and (B). The electric cutting machine 800 of Eighth Embodiment is configured similarly to the electric cutting machine 10 of

First Embodiment, except for the points described below. In FIGS. 16(A) and (B), members configured similarly to those in the electric cutting machine 10 of First Embodiment will be labeled with the same reference signs.

In other words, in Eighth Embodiment, the housing 20 includes a lifter housing part 20F similar to those in Sixth Embodiment and Seventh Embodiment, a motor housing part 20B constituting a middle part in the front-rear direction of the housing 20, and a handle housing part 20A constituting a rear end part of the housing 20. The lifter housing part 20F constitutes a front end part of the housing 20, and a feed screw mechanism 50 is accommodated in the lifter housing part 20F. The motor housing part 20B protrudes toward the lower side from a rear end part of the lifter housing part 20F, and a motor 40 is accommodated in the motor housing part 20B.

Further, a battery mounting part 20D is provided at a rear end part of the lifter housing part 20F. The battery mounting part 20D protrudes toward the upper side from the lifter housing part 20F, and a battery 24 mounted to the battery mounting part 20D protrudes more upward than the battery mounting part 20D. The handle housing part 20A is extended along a direction that is inclined toward the lower side as it extends toward the rear side when viewed from the left side. Further, a handle guard 20C is extended toward the rear side from a lower end part of the motor housing part 20B, and a rear end part of the handle guard 20C is connected to a lower end part of the handle housing part 20A. Further, a controller 90 is accommodated in a front end part of the handle housing part 20A.

In Eighth Embodiment as well, in a side view, a center of gravity G8 of the electric

cutting machine 800 is located at a position overlapping with a blade 60 and a support part 80A in the up-down direction of the electric cutting machine 800. Specifically, in the side view, the center of gravity G8 overlaps with the lifter housing part 20F, and is located within a range of a width dimension B of the blade 60 and within a range of a width dimension A of the support part 80A in the up-down direction. Thus, in an upright posture of the electric cutting machine 800, the center of gravity G8 of the electric cutting machine 800 is located on the vertically lower side of the blade 60 for cutting the workpiece W. Accordingly, similarly to First Embodiment, operability of the electric cutting machine 800 can be improved.

Furthermore, in Eighth Embodiment, a front end part of the gripping part 20A2 gripped by the operator is disposed on the rear side of the head part 80 and overlaps with the support part 80A of the head part 80 when viewed from the front-rear direction. Specifically, when viewed from the left-right direction, the front end part of the gripping part 20A2 is disposed within the range of the width dimension A of the support part 80A, and extends along a direction that is inclined toward the lower side as it extends toward the rear side. In other words, when viewed from the left-right direction, the front end part of the gripping part 20A2 is at a same position as the support part 80A in the up-down direction. Thus, similarly to First Embodiment, when setting a workpiece W, which serves as a light gauge steel fixed to a ceiling and the like, to the electric cutting machine 800, the front end part of the gripping part 20A2 is disposed on the vertically lower side of the support part 80A. As a result, with the operator gripping the front end part of the gripping part 20A2, the workpiece W can be easily set to the support part 80A of the head part 80. According to the above, operability of the electric cutting machine 800 can be improved. Further, since the gripping part 20A2 is inclined with respect to the front-rear direction, a weight when orienting the head part 80 upward can be received by the palm of the hand, which forms a configuration that is less tiring.

Further, in Eighth Embodiment, a trigger 30 is provided at the front end part of the gripping part 20A2, and a part of the trigger 30 overlaps with the support part 80A when viewed from the front-rear direction. Specifically, when viewed from the left-right direction, a part of the trigger 30 is disposed within the range of the width dimension A of the support part 80A. Accordingly, similarly to First Embodiment, the trigger 30 can be operated with the operator's hand gripping the gripping part 20A2 while maintaining a state in which the operator's hand is located on the rear side of the support part 80A. Thus, operability of the electric cutting machine 800 can be further improved.

Further, in Eighth Embodiment, the housing 20 is extended in the front-rear direction, and the gripping part 20A2 constitutes a rear end part of the housing 20. Thus, when setting a workpiece W, which serves as a light gauge steel fixed to a ceiling and the like, to the electric cutting machine 800, the gripping part 20A2 can be positioned on the vertically lower side compared to First Embodiment. As a result, a lifting amount of the electric cutting machine 800 lifted by the operator can be reduced. Accordingly, operability of the electric cutting machine 800 can be further improved.

Thus, in Eighth Embodiment, the motor housing part 20B and the battery mounting part

20D are disposed at a middle part in the front-rear direction of the housing 20, and are arranged in a row in the up-down direction. Accordingly, the gripping part 20A2 can be set at the rear end part of the housing 20 while disposing and concentrating the motor 40 and the battery 24 at the middle part in the front-rear direction of the housing 20.

### Ninth Embodiment

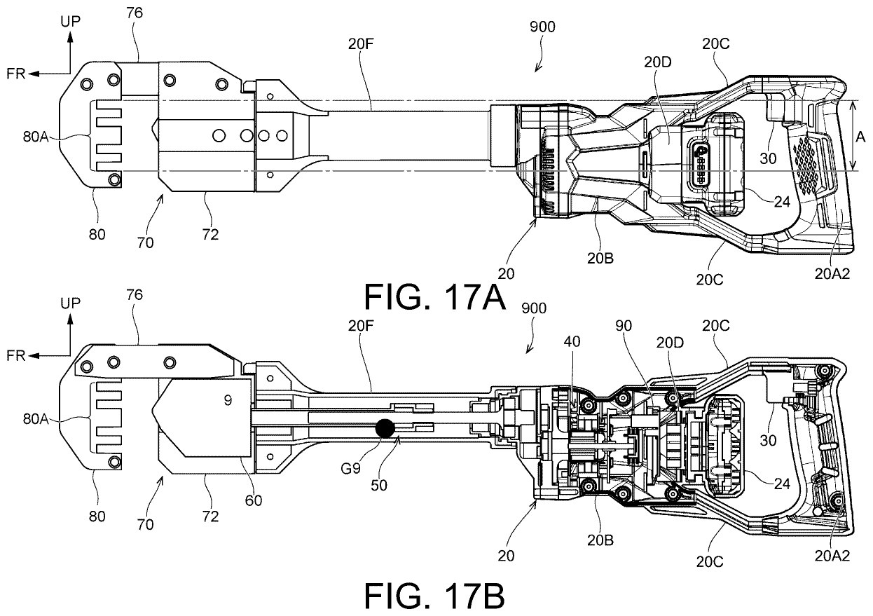

Next, an electric cutting machine 900 as a work machine of Ninth Embodiment will be described with reference to FIGS. 17(A) and (B). The electric cutting machine 900 of Ninth Embodiment is configured similarly to the electric cutting machine 10 of First Embodiment, except for the points described below. In FIGS. 17(A) and (B), members configured similarly to those in the electric cutting machine 10 of First Embodiment will be labeled with the same reference signs.

In other words, in Ninth Embodiment, the housing 20 is extended in the front-rear direction, and a front-rear dimension of the housing 20 is set to be larger than that in First Embodiment. The housing 20 includes a lifter housing part 20F similar to that in Eighth Embodiment, a motor housing part 20B constituting a middle part in the front-rear direction of the housing 20, and a gripping part 20A2 constituting a rear end part of the housing 20.

The lifter housing part 20F constitutes a front end part of the housing 20, and a feed screw mechanism 50 is accommodated in the lifter housing part 20F. The motor housing part 20B is disposed on the rear side of the lifter housing part 20F, a lower part of the motor housing part 20B protrudes more downward than the lifter housing part 20F, and a motor 40 is accommodated in the motor housing part 20B. Further, a battery mounting part 20D is provided at a rear end part of the motor housing part 20B, and a battery 24 protrudes toward the rear side from the battery mounting part 20D. A controller 90 is accommodated in the motor housing part 20B.

The gripping part 20A2 is disposed spaced apart from the battery 24 on the rear side and is extended along a substantially up-down direction. The housing 20 includes a pair of upper and lower handle guards 20C, and the handle guards 20C are extended toward the front side from both longitudinal end parts of the gripping part 20A2 and are connected to the rear end part of the motor housing part 20B.

In Ninth Embodiment as well, in a side view, a center of gravity G9 of the electric cutting machine 900 is located at a position overlapping with a blade 60 and a support part 80A in the up-down direction of the electric cutting machine 900. Specifically, in the side view, the center of gravity G9 overlaps with the lifter housing part 20F, and is located within a range of a width dimension B of the blade 60 and within a range of a width dimension A of the support part 80A in the up-down direction. Thus, in an upright posture of the electric cutting machine 900, the center of gravity G9 of the electric cutting machine 900 is located on the vertically lower side of the blade 60 for cutting the workpiece W. Accordingly, similarly to First Embodiment, operability of the electric cutting machine 900 can be improved.

Furthermore, in Ninth Embodiment, an upper part of the gripping part 20A2 gripped by the operator is disposed on the rear side of the head part 80 and overlaps with the support part 80A of the head part 80 when viewed from the front-rear direction. Specifically, when viewed from the left-right direction, the upper part of the gripping part 20A2 is disposed within the range of the width dimension A of the support part 80A, and the gripping part 20A2 is extended in the up-down direction. In other words, when viewed from the left-right direction, the upper part of the gripping part 20A2 is at a same position as the support part 80A in the up-down direction. Thus, similarly to First Embodiment, when setting a workpiece W, which serves as a light gauge steel fixed to a ceiling and the like, to the electric cutting machine 900, the upper part of the gripping part 20A2 is disposed on the vertically lower side of the support part 80A. As a result, with the operator gripping the upper part of the gripping part 20A2, the workpiece W can be easily set to the support part 80A of the head part 80. According to the above, operability of the electric cutting machine 900 can be improved.

Further, in Ninth Embodiment, a trigger 30 is provided at an upper end part of the gripping part 20A2, and a part of the trigger 30 overlaps with the support part 80A when viewed from the front-rear direction. Specifically, when viewed from the left-right direction, a part of the trigger 30 is disposed within the range of the width dimension A of the support part 80A (at a same position as the support part 80A in the up-down direction). Accordingly, similarly to First

Embodiment, the trigger 30 can be operated with the operator's hand gripping the gripping part 20A2 while maintaining a state in which the operator's hand is located on the rear side of the support part 80A. Thus, operability of the electric cutting machine 900 can be further improved.

Further, in Ninth Embodiment, the housing 20 is extended in the front-rear direction, and the gripping part 20A2 constitutes the rear end part of the housing 20. Thus, similarly to Eighth

Embodiment, when setting a workpiece W, which serves as a light gauge steel fixed to a ceiling and the like, to the electric cutting machine 900, the gripping part 20A2 can be positioned the vertically lower side compared to First Embodiment. As a result, a lifting amount of the electric cutting machine 900 lifted by the operator can be reduced.

Further, in Ninth Embodiment, the motor housing part 20B and the battery mounting part 20D are disposed at the middle part in the front-rear direction of the housing 20, and are arranged in a row in the front-rear direction. Accordingly, similarly to Eighth Embodiment, the gripping part 20A2 can be set at the rear end part of the housing 20 while disposing and concentrating the motor 40 and the battery 24 at the middle part in the front-rear direction of the housing 20.

### Tenth Embodiment

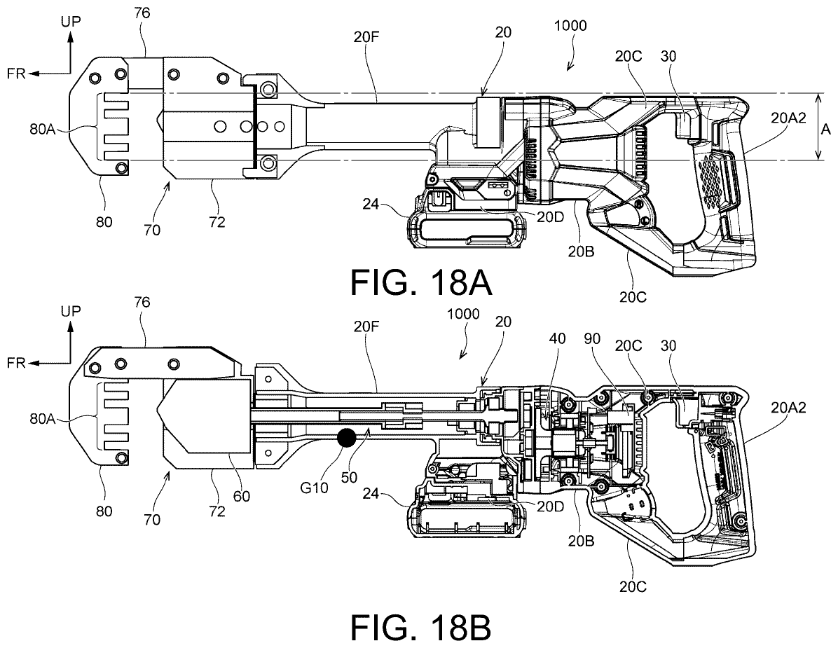

Next, an electric cutting machine 1000 as a work machine of Tenth Embodiment will be described with reference to FIGS. 18(A) and (B). The electric cutting machine 1000 of Tenth Embodiment is configured similarly to the electric cutting machine 10 of First Embodiment, except for the following points. In FIGS. 18(A) and (B), members configured similarly to those in the electric cutting machine 10 of First Embodiment will be labeled with the same reference sings.

In other words, in Tenth Embodiment, the housing 20 is extended in the front-rear direction, and a front-rear dimension of the housing 20 is set to be larger than that in First Embodiment. The housing 20 includes a lifter housing part 20F similar to that in Ninth Embodiment, a motor housing part 20B constituting a middle part in the front-rear direction of the housing 20, and a gripping part 20A2 constituting a rear end part of the housing 20.

The lifter housing part 20F constitutes a front end part of the housing 20, and a feed screw mechanism 50 is accommodated in the lifter housing part 20F. The motor housing part 20B is disposed on the rear side of the lifter housing part 20F, and a lower part of the motor housing part 20B protrudes more downward than the lifter housing part 20F. A motor 40 and a controller 90 are accommodated in the motor housing part 20B. Further, a battery mounting part 20D protruding toward the lower side is provided at a rear end part of the lifter housing part 20F, and a battery 24 protrudes toward the lower side from the battery mounting part 20D.

The gripping part 20A2 is disposed spaced apart from the motor housing part 20B on the rear side and is extended along a substantially up-down direction. The housing 20 includes a pair of upper and lower handle guards 20C, and the handle guards 20C are extended toward the front side from both longitudinal end parts of the gripping part 20A2 and are connected to the rear end part of the motor housing part 20B.

In Tenth Embodiment as well, in a side view, a center of gravity G10 of the electric cutting machine 1000 is located at a position overlapping with a blade 60 and a support part 80A in the up-down direction of the electric cutting machine 1000. Specifically, in the side view, the center of gravity G10 overlaps with the lifter housing part 20F and is located within a range of a width dimension B of the blade 60 and within a range of a width dimension A of the support part 80A in the up-down direction. Thus, in an upright posture of the electric cutting machine 1000, the center of gravity G10 of the electric cutting machine 1000 is located on the vertically lower side of the blade 60 for cutting the workpiece W. Accordingly, similarly to First Embodiment, operability of the electric cutting machine 1000 can be improved.

Furthermore, similar to Ninth Embodiment, in Tenth Embodiment, an upper part of the gripping part 20A2 gripped by the operator is disposed on the rear side of the head part 80 and overlaps with the support part 80A of the head part 80 when viewed from the front-rear direction. Specifically, when viewed from the left-right direction, the upper part of the gripping part 20A2 is disposed within the range of the width dimension A of the support part 80A, and extends along a direction that is inclined toward the lower side as it extends toward the rear side. Thus, similarly to Ninth Embodiment, with the operator gripping the upper part of the gripping part 20A2, the workpiece W can be easily set to the support part 80A of the head part 80. According to the above, operability of the electric cutting machine 1000 can be improved.

Further, similar to Ninth Embodiment, in Tenth Embodiment, a trigger 30 is provided at the upper end part of the gripping part 20A2, and the trigger 30 overlaps with the support part 80A when viewed from the front-rear direction. Specifically, when viewed from the left-right direction, the trigger 30 is disposed within the range of the width dimension A of the support part 80A. Accordingly, similarly to Ninth Embodiment, the trigger 30 can be operated with the operator's hand gripping the gripping part 20A2 while maintaining a state in which the operator's hand is located on the rear side of the support part 80A. Thus, operability of the electric cutting machine 1000 can be further improved.

Further, in Tenth Embodiment, the housing 20 is extended in the front-rear direction, and the gripping part 20A2 constitutes the rear end part of the housing 20. Thus, similarly to Ninth Embodiment, when setting a workpiece W, which serves as a light gauge steel fixed to a ceiling and the like, to the electric cutting machine 1000, the gripping part 20A2 can be positioned on the vertically lower side. As a result, a lifting amount of the electric cutting machine 1000 lifted by the operator can be reduced.

Further, in Tenth Embodiment, the motor housing part 20B and the battery mounting part 20D are disposed at the middle part in the front-rear direction of the housing 20, and are arranged in a row in the front-rear direction. Accordingly, similarly to Fifth Embodiment, the gripping part 20A2 can be set at the rear end part of the housing 20 while disposing and concentrating the motor 40 and the battery 24 at the middle part in the front-rear direction of the housing 20.

### REFERENCE SIGNS LIST

10 . . . Electric cutting machine (work machine), 20 . . . Housing, 20A . . . Handle housing part (gripping part), 20A2 . . . Gripping part, 22 . . . Battery terminal (power supply part), 40 . . . Motor, 60 . . . Blade (cutting tool), 60A . . . Blade part, 60B . . . Tip part of blade part, 80A . . . Support part, 200 . . . Electric cutting machine (work machine), 300 . . . Electric cutting machine (work machine), 400 . . . Electric cutting machine (work machine), 500 . . . Electric cutting machine (work machine), G1 . . . Center of gravity, G2 . . . Center of gravity, G3 . . . Center of gravity, G4 . . . Center of gravity, G5 . . . Center of gravity, G6 . . . Center of gravity, G7 . . . Center of gravity, G8 . . . Center of gravity, G9 . . . Center of gravity, G10 . . . Center of gravity, W . . . Workpiece (light gauge steel)

1. A work machine comprising:
a housing extending in a first direction; and
a cutting tool that is provided to be capable of reciprocating in the first direction on one side of the housing in the first direction, is formed into a plate shape with a second direction orthogonal to the first direction as a width direction and a third direction orthogonal to the first direction and the second direction as a plate thickness direction, and cuts a light gauge steel by moving toward the one side in the first direction, wherein
a support part supporting the light gauge steel is provided on the one side in the first direction with respect to the cutting tool,
a blade part in a V-shape that is convex toward the one side in the first direction upon viewing from the third direction is formed at a one-side end part of the cutting tool in the first direction,
in the second direction, a tip part of the blade part is disposed at a position offset to one side in the second direction with respect to a central part of the support part in the second direction, and
upon viewing from the third direction, a center of gravity of the work machine is located at a position overlapping with the cutting tool in the second direction, and the center of gravity is located at a position offset to another side in the second direction with respect to the central part of the support part in the second direction.

2. The work machine according to claim 1, wherein the housing comprises a gripping part, and at least a part of the gripping part is disposed at a position overlapping with the center of gravity in the first direction.

3. The work machine according to claim 2, wherein the gripping part extends in the first direction.

4. (canceled)

5. The work machine according to claim 1, wherein a motor for causing the cutting tool to reciprocate is accommodated in the housing, and
the motor is disposed at a position offset to the one side in the second direction with respect to the central part of the support part in the second direction.

6. The work machine according to claim 5, wherein a power supply part for supplying power to the motor is provided at the housing, and the power supply part is disposed at a position offset to the another side in the second direction with respect to a center of the support part in the second direction.

7. The work machine according to claim 2, wherein, upon viewing from the third direction, a part of the gripping part is located outside a virtual circle that is centered on the central part of the support part in the second direction and passes through the center of gravity.

8. The work machine according to claim 2, wherein, upon viewing from the first direction, a part of the gripping part is located at a position overlapping with the support part.

9. (canceled)

10. The work machine according to claim 2, wherein an operation part instructing a movement start of the cutting tool is provided at the gripping part, and
upon viewing from the first direction, at least a part of the operation part overlaps with the support part.

11. The work machine according to claim 10, wherein the gripping part is extended in the first direction, and the operation part is disposed at a one-side end part of the gripping part in the first direction.

12. The work machine according to claim 2, comprising:
a housing extended in the first direction and disposed on the another side of the cutting tool in the first direction; and
a motor for driving the cutting tool, wherein
the gripping part constitutes a one-side portion of the housing in the first direction, and
an other-side end part of the housing in the first direction is configured as a motor housing part accommodating the motor.

13. The work machine according to claim 12, wherein a direction orthogonal to the first direction is taken as a second direction, and
a battery mounting part for mounting a battery supplying power to the motor is provided at the motor housing part, and the battery mounting part is disposed on one side of the motor in the second direction.

14. The work machine according to claim 13, wherein the housing comprises a guard part extended in the first direction, and
the guard part is disposed on the one side of the gripping part in the second direction and on the one side of the battery mounting part in the first direction.

15. A work machine comprising:
a cutting tool is configured to be capable of reciprocating, by a motor, between an initial position and a processing position;
a processing part comprising a support part that has several notch parts spaced apart with predetermined interval for supporting a U-shaped workpiece;
a gripping part extending along a first direction, and is provided on one side in the first direction with respect to the processing part;
an operation part for turning on and off the motor, provided on the gripping part;
a battery supplying power to the motor; and
a motor housing part provided on another side in the first direction with respect to the gripping part and holding the motor and the battery, wherein
a center of gravity of the work machine with the battery is located between the processing part and the motor housing part in the first direction.

16. The work machine according to claim 3, wherein an operation part for instructing movement start of the cutting tool is provided at the gripping part, and the center of gravity is located on the one side in the first direction with respect to the operation part.

17. The work machine according to claim 1, wherein, upon viewing from the first direction, the cutting tool and the center of gravity overlap with each other.

18. The work machine according to claim 15, wherein at least a part of a drive shaft for transmitting a drive force of the motor to the cutting tool is positioned in the gripping part,
wherein the drive shaft extends along the first direction,
wherein a center of the motor is positioned offset from a center axis line of the drive shaft in a second direction crossing the first direction, and
wherein the center of gravity of the work machine is positioned offset from the center axis line of the drive shaft in the second direction.
